(19) United States
(12) Patent Application Publication
(10) Pub. No.: US 2025/0138320 A1
(43) Pub. Date: May 1, 2025

(54) DYNAMIC PUSH-PULL LENSES FOR XR DISPLAYS

(71) Applicant: Snap Inc., Santa Monica, CA (US)

(72) Inventors: Mario Ariosto Matranga, Chandler, AZ (US); Miller Harry Schuck, III, Erie, CO (US); Kenneth Scott Kubala, Boulder, CO (US)

(21) Appl. No.: 18/919,314

(22) Filed: Oct. 17, 2024

Related U.S. Application Data
(60) Provisional application No. 63/594,221, filed on Oct. 30, 2023.

(51) Int. Cl. G02B 27/01; G02B 27/00; G02C 7/08

(52) U.S. Cl. CPC G02B 27/0172; G02B 27/0093; G02C 7/083; G02C 7/086; G02B 2027/0129; G02B 2027/0134; G02B 2027/014; G02B 2027/0178; G02C 2202/12

(57) ABSTRACT

An XR display system includes a near-eye optical see-through XR display having an image presentation component with an eye-facing side and a world-facing side and configured to present virtual visual content to a user's eye from locations across an image presentation surface of the eye-facing side. A dynamic push lens positioned on the world-facing side and a dynamic pull lens positioned on the eye-facing side each include a liquid crystal cell dynamically switchable by an electrical stimulus between an inactive state and an active state. In the active state, the dynamic push lens converges environmental light approaching the image presentation component from the world-facing side by applying a positive optical power, and the dynamic pull lens diverges light passing out of the eye-facing side of the image presentation component toward the user's eye by applying a negative optical power.

### CLAIM OF PRIORITY

This application claims the benefit of priority to U.S. Provisional Application Ser. No. 63/594,221, filed on Oct. 30, 2023, which is incorporated herein by reference in its entirety

### TECHNICAL FIELD

The present disclosure relates generally to display devices and more particularly to display devices used for extended reality.

### BACKGROUND

A head-worn device may be implemented with a transparent or semi-transparent display through which a user of the head-worn device can view the surrounding environment. Such devices enable a user to see through the transparent or semi-transparent display to view the surrounding environment, and to also see objects or other content (e.g., virtual objects such as 3D renderings, images, video, text, and so forth) that are generated for display to appear as a part of, and/or overlaid upon, the surrounding environment (referred to collectively as “virtual content”). This is typically referred to as “extended reality” or “XR”, and it encompasses techniques such as augmented reality (AR), virtual reality (VR), and mixed reality (MR). Each of these technologies combines aspects of the physical world with virtual content presented to a user.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1A illustrates an image presentation component of an XR display system with passive push/pull lenses, according to some examples.

FIG. 1B illustrates the image presentation component of FIG. 1A with dynamic push/pull lenses supplementing the static push/pull lenses, according to some examples.

FIG. 2 is a perspective view of a head-worn device, in accordance with some examples.

FIG. 3 illustrates a further view of the head-worn device of FIG. 2, in accordance with some examples.

FIG. 4 is a simplified cross-sectional view of an example near-eye optical see-through XR display having dynamic push/pull lenses, in accordance with some examples.

FIG. 5 illustrates a binocular pair of image presentation components presenting virtual visual content to a pair of eyes, according to some examples.

FIG. 6 is a flowchart showing operations of a method for switching between activation states of dynamic push/pull lenses of an XR display system, according to some examples.

FIG. 7 illustrates a front view of a first liquid crystal cell showing parallel liquid crystal alignment directions across a surface of the liquid crystal cell, according to some examples.

FIG. 8A illustrates a magnified front view of the liquid crystal cell of FIG. 7, showing alignment of individual liquid crystals across the surface, according to some examples.

FIG. 8B illustrates a magnified side cross-sectional view of the liquid crystal cell of FIG. 7, showing alignment of individual liquid crystals within layers stacked depth-wise, according to some examples.

FIG. 9 illustrates a front view of a second liquid crystal cell showing radial liquid crystal alignment directions across a surface of the liquid crystal cell, according to some examples.

FIG. 10 illustrates a magnified front view of the liquid crystal cell of FIG. 9, showing alignment of individual liquid crystals across the surface, according to some examples.

FIG. 11 illustrates a front view of a third liquid crystal cell showing circular liquid crystal alignment directions across a surface of the liquid crystal cell, according to some examples.

FIG. 12 illustrates a front view of a fourth liquid crystal cell showing parallel liquid crystal alignment in a first direction across a first surface of the liquid crystal cell, according to some examples.

FIG. 13 illustrates a rear view of the liquid crystal cell of FIG. 12, showing parallel liquid crystal alignment in a second direction across a second surface of the liquid crystal cell, according to some examples.

FIG. 14A illustrates a magnified side cross-sectional view of the liquid crystal cell of FIG. 12 and FIG. 13, showing alignment of individual liquid crystals within layers stacked depth-wise, according to some examples.

FIG. 14B illustrates a magnified front cross-sectional view of a first layer of the liquid crystal cell of FIG. 12 and FIG. 13, showing alignment of individual liquid crystals within the layer, according to some examples.

FIG. 14C illustrates a magnified front cross-sectional view of an intermediate layer of the liquid crystal cell of FIG. 12 and FIG. 13, showing alignment of individual liquid crystals within the layer, according to some examples.

FIG. 14D illustrates a magnified front cross-sectional view of a final layer of the liquid crystal cell of FIG. 12 and FIG. 13, showing alignment of individual liquid crystals within the layer, according to some examples.

FIG. 15 illustrates a graph of the refractive index across a surface of an example Fresnelized GRIN lens, according to some examples.

FIG. 16 illustrates a front view of a liquid crystal cell coupled to a dimmer for blocking light in a peripheral region, according to some examples.

FIG. 17 is a diagrammatic representation of a machine in the form of a computer system within which a set of instructions may be executed to cause the machine to perform any one or more of the methodologies discussed herein, according to some examples.

FIG. 18 is a block diagram showing a software architecture within which examples may be implemented.

### DETAILED DESCRIPTION

XR displays are typically categorized as video pass-through displays or optical see-through displays. In video pass-through, a view of the physical environment is captured by a camera, combined with virtual content, and then presented to the user on an opaque display. In optical see-through, a user views the physical environment directly through transparent or translucent displays which interpose virtual content between the user's eyes and the physical environment.

Optical see-through XR displays have two major design goals: first, ensuring that the display can present realistic-looking virtual content to the user's eyes; and, second, ensuring that the display can permit a relatively unobstructed see-through view of the physical environment. Achieving both of these goals can present challenges. One challenge is the question of how to present the virtual content such that it appears to be at a specific distance from the user, in a way that feels natural and comfortable to the user's ocular and perceptual systems, while leaving the real-world visual field undistorted. Many near-eye XR displays are limited to projecting virtual visual content to the user's eyes such that the focal distance of the virtual objects appears to be infinite: in order for the user's eyes to bring the virtual object into focus, the eyes must behave as if the object were very far away. This means that all virtual content is in focus at a great distance from the user, and interferes with the intended perception that the virtual objects are interacting with real-world objects at a common depth of field or distance from the user.

To address this limitation, some examples described herein may use a combination of passive and/or active push/pull lenses located on opposite sides of the waveguide or other transparent image presentation component used to present virtual visual content to the user's eye. A “pull” lens, located on an eye-facing side of the waveguide surface, operates to diverge light (or “pull” the image from infinity to a finite distance in front of the eye) traveling away from the waveguide as it approaches the user's eye, thereby causing the light from the waveguide to appear closer. Thus, a pull lens on the eye-facing side of the waveguide may cause the virtual visual content to appear closer than the default focal distance of infinity; for example, a pull lens may be configured to provide negative one diopter (−1D) of optical power, making the virtual visual content appear to be at a focal distance of 1 meter from the user's eye.

However, while the pull lens on the eye-facing side of the waveguide is effective to achieve the goal of making the virtual visual content appear nearer than infinity, it applies a similar distortion to environmental light from the real-world visual field passing through the waveguide from a world-facing side, exiting through the eye-facing side, passing through the pull lens, and traveling to the user's eye. Without further correction, this would result in a grossly distorted view of the real-world visual field. Thus, a second corrective ophthalmic lens, called a “push lens”, may be placed on the world-facing side of the waveguide opposite the eye-facing side. This push lens applies an equal and opposite optical power to that applied by the pull lens (e.g., the push lens may apply optical power of +1D), such that the environmental light from the real world arrives at the user's eye undistorted, as the push lens and pull lens cancel each other's effects with respect to light passing through both lenses.

Thus, using passive ophthalmic push/pull lenses can cause virtual visual content to appear at a selected apparent focal distance from the user. However, human depth perception is affected not only by the focal distance of a visual object, but also the object's vergence distance, which refers to the distance from the user where the gaze vectors of the user's two eyes intersect when looking at an object in space. By presenting the virtual visual content at slightly different relative locations on the left and right near-eye optical displays of a binocular near-eye display system, the gaze direction of each of the user's eyes can be drawn to a different gaze angle when looking at the virtual visual content with both eyes, allowing the XR display system to specify a vergence distance that further causes the user's perceptual and ocular systems to perceive the virtual visual content as being located at that distance.

However, XR display systems that use vergence to manipulate the user's perception of the depth of virtual visual content can cause discomfort in users if there is a mismatch between vergence distance and focal distance. If an XR display system uses passive push/pull lenses to set focal distance at a fixed depth (e.g., 1 meter), any virtual visual content presented at a vergence distance of significantly more or less than the fixed depth (e.g., greater or less than 1 meter) can cause discomfort in users and may also degrade the perceived realism of the virtual visual content.

Thus, in some examples, dynamic lenses may be used in place of, or in addition to, passive ophthalmic push/pull lenses. Dynamic lenses may be configured to switch between an active state (in which they apply optical power to light passing through them) and a passive state (in which they apply zero optical power to the light passing through them). In some examples, the dynamic lenses may be configured to vary their optical power between more than two states, such as over a continuous range of optical power levels. Some examples use a single pair of dynamic push/pull lenses to cause virtual visual content to appear closer when switched to their active state; other examples may also include a second pair of push/pull lenses, with the push lens on the eye-facing side and the pull lens on the world-facing side, such that they cause virtual visual content to appear farther away when switched to their active state. Any of these configurations can be combined with passive push/pull lenses, such that the passive lenses provide a baseline focal distance for virtual visual content (e.g., 1 meter) when the dynamic lenses are inactive, and the dynamic lenses may be activated to vary this baseline focal distance (e.g., by applying a further −1D optical power to the virtual visual content for a total of −2D, making the virtual visual content appear at a focal distance of 0.5 meters).

By using dynamic push/pull lenses, examples described herein may attempt to address one or more technical problems related to XR display systems. An XR display system with dynamic push/pull lenses may allow vergence distance to be varied over a greater range of depths without significant loss of visual realism and without causing discomfort to users, thereby enhancing the realism of virtual visual content and expanding the range of perceived distances at which the virtual visual content can be presented.

In some examples, the dynamic push/pull lenses may be implemented using liquid crystal (LC) cells driven by ring electrodes to form a lens with a uniform thickness but a dynamically variable refractive index across its surface area, through the action of electronically controlled birefringence (ECB). A dynamic push lens may mimic the effects of a convex lens or a Fresnel lens, converging light that passes through it. This may be achieved by inducing in the liquid crystals located across the surface area of the liquid crystal cell a spatially varied electrical field such that areas in a center region of the lens have a high refractive index and areas in a peripheral region of the lens have a lower refractive index. Conversely, the dynamic pull lens may mimic the effects of a concave lens, diverging light that passes through it, by inducing a spatially varied electrical field such that areas in a center region of the lens have a low refractive index and areas in a peripheral region of the lens have a higher refractive index.

Dynamic liquid crystal lenses may present various additional technical problems relating to non-uniform liquid crystal response to directional electric fields as a result of directional LC alignment, and/or relating to the ability of the LC cell to apply optical power to light of different polarizations. Some examples described herein present various techniques that attempt to address these technical problems.

As used herein, the terms “active lens” and “dynamic lens” may be used interchangeably, as may the terms “static lens” and “passive lens”.

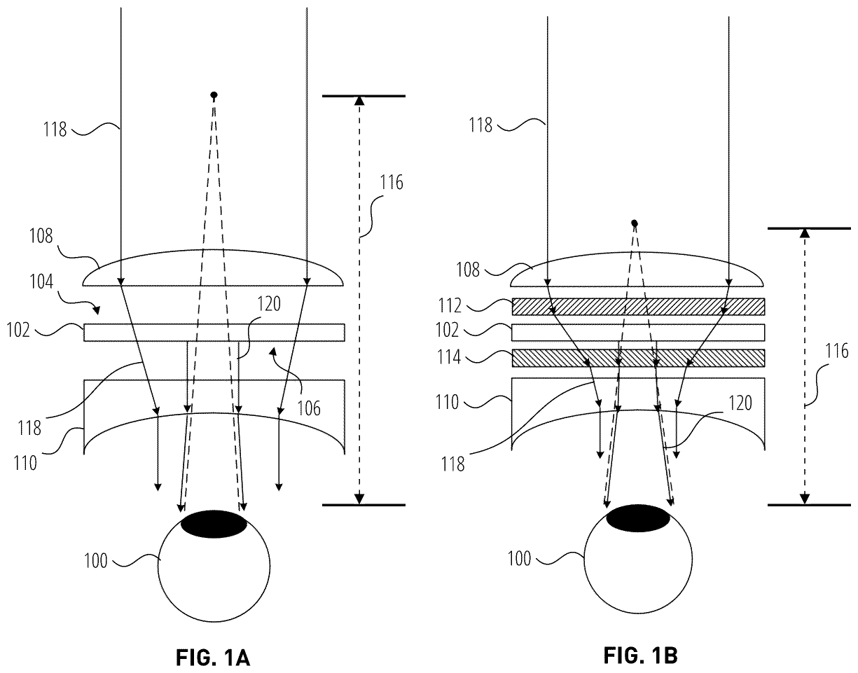

FIG. 1A illustrates an image presentation component 102 of an XR display system with passive push/pull lenses. The image presentation component 102 may be a waveguide or other transparent (or substantially transparent) components used to project or otherwise present visual content to a user's eye 100.

A static push lens 108, shown as a convex ophthalmic lens, is positioned on a world-facing side 104 of the image presentation component 102, which is a side of the image presentation component 102 opposite the direction of the user's eye 100. A static pull lens 110, shown as a concave ophthalmic lens, is positioned on an eye-facing side 106 of the image presentation component 102, which is a side of the image presentation component 102 in the same direction as the user's eye 100. The static push lens 108 and static pull lens 110 have optical powers that negate each other (e.g., +1D and −1D respectively) in examples described herein.

Virtual visual content is projected from the image presentation component 102 toward the eye 100 as projected light 120. When it passes out of the image presentation component 102, the virtual visual content has a focal distance of infinity, shown as parallel beams of projected light 120. However, after passing through the static pull lens 110, the projected light 120 diverges, giving the virtual visual content a perceived focal distance 116 closer than infinity (e.g., 1 meter for a static pull lens 110 applying −1 diopter of optical power).

The real-world visual field is propagated toward the XR display system and the user's eye 100 as environmental light 118. The environmental light 118 passes through the static push lens 108, which causes it to converge; the environmental light 118 then propagates through the transparent image presentation component 102 and passes through the static pull lens 110, which diverges the environmental light 118, thereby correcting for the convergence caused by the static push lens 108. The environmental light 118 thus reaches the eye 100 having the same apparent depth as it would without the presence of the static push lens 108 and static pull lens 110.

FIG. 1B illustrates an image presentation component 102, as in FIG. 1A, with dynamic push/pull lenses supplementing the static push/pull lenses. In this example, a dynamic push lens 112 is located on the world-facing side 104 of the image presentation component 102 to supplement the static push lens 108, and a dynamic pull lens 114 is located on the eye-facing side 106 to supplement the static pull lens 110. As in the examples of paired static push/pull lenses described herein, the paired dynamic push/pull lenses have optical powers that negate each other (e.g., +1D and −1D) when activated.

In some examples, the dynamic push lens 112 includes a liquid crystal cell dynamically switchable by an electrical stimulus between an inactive state and an active state. In the active state, the dynamic push lens 112 converges the environmental light 118 approaching the image presentation component 102 from the world-facing side 104, such that the dynamic push lens 112, when in the active state, applies a positive optical power (e.g., +1D) to the environmental light 118. In the passive state, the dynamic push lens 112 may apply zero optical power to the environmental light 118.

In some examples, the dynamic pull lens 114 also includes a liquid crystal cell dynamically switchable by an electrical stimulus between an inactive state and an active state. In the active state, the dynamic pull lens 114 diverges light passing out of the eye-facing side 106 of the image presentation component 102 toward the user's eye (e.g., both environmental light 118 and projected light 120 in the illustrated example), such that the dynamic pull lens 114, when in the active state, applies a negative optical power (e.g., −1D) to the light. In the passive state, the dynamic pull lens 114 may apply zero optical power to the light.

In some examples, the dynamic push lens 112 and dynamic pull lens 114 may be operable to switch between multiple different active states applying different levels of optical power, or to vary their applied optical power continuously over a range of values, based on an applied electrical stimulus.

Thus, in examples using a static push lens 108 applying +1D, a dynamic push lens 112 applying +1D when active, a dynamic pull lens 114 applying −1D when active, and a static pull lens 110 applying −1D, the perceived focal distance of the virtual visual content will be 1 meter when the dynamic push lens 112 and dynamic pull lens 114 are in the inactive state, and 0.5 meters when the dynamic push lens 112 and dynamic pull lens 114 are in the active state. These focal distances may enable the XR display system to present virtual visual content suited to a number of common applications: the 1 meter focal distance may be suitable for presentation of virtual visual content that appears to be in the same social space as the user without intruding into the user's personal space, whereas the 0.5 meter focal distance may be suitable for presentation of virtual visual content that the user wishes to inspect closely, such as textual information presented on the palm of a user's hand.

Experimental testing of different vergence distances in combination with different focal distances of virtual visual content on near-eye XR displays suggests that virtual visual content with a focal distance of 1.0 meter results in little or no discomfort for most users when presented at a vergence distance between 0.67 meters and 2.00 meters (referred to herein as the “comfort zone” of vergence distances for a given focal distance). Furthermore, virtual visual content with a focal distance of 0.5 meters results in little or no discomfort for most users when presented at a vergence distance between 0.40 meters and 0.67 meters. Thus, an example XR display system with passive and active push/pull lenses operable to vary the focal distance of virtual visual content between 1.0 meter and 0.5 meters may be effective to enable the presentation of virtual visual content at any vergence distance (and therefore effectively any perceived depth) from 0.4 meters to 2.00 meters.

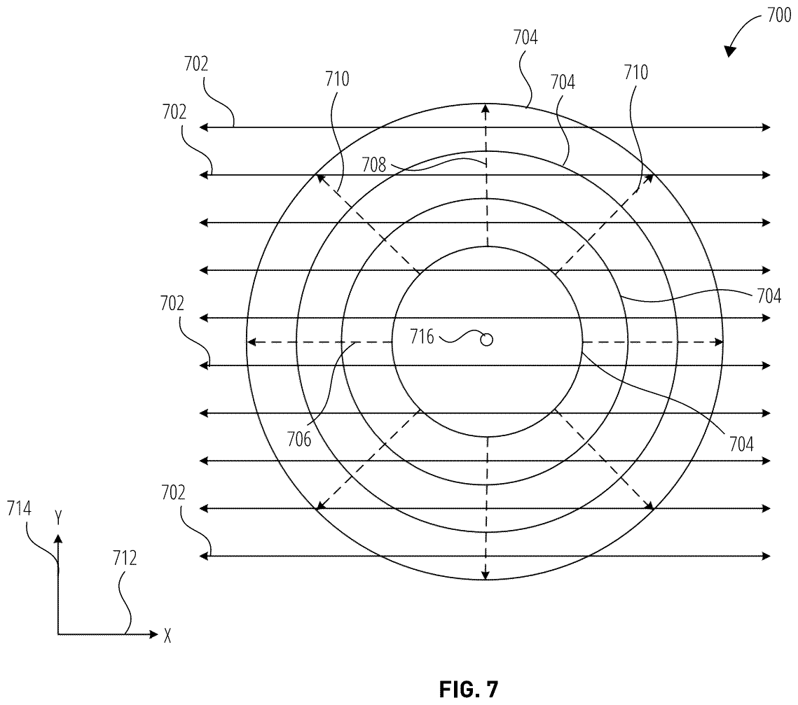

Example implementations of the dynamic push lens 112 and dynamic pull lens 114 are described below, with reference to FIG. 7 through FIG. 16, as LC cells configured with ring electrodes for application of the electrical stimulus to switch states. However, it will be appreciated that the dynamic push lens 112 and/or dynamic pull lens 114 may be implemented using other means in some examples, such as thermally reactive materials, materials configured to physically deform in response to an applied stimulus (for example electrowetting on dielectric lenses), and so on.

Although not shown in FIG. 1B, some examples may add a further second pair of dynamic push/pull lenses, with their positions reversed from the dynamic push lens 112 and dynamic pull lens 114 shown in FIG. 1B: the second dynamic push lens can be positioned on the eye-facing side, and the second dynamic pull lens positioned on the world-facing side, such that they cause the virtual visual content to appear farther away when switched to their active state. Such a configuration could provide a baseline optical power applied by the passive lenses to present the virtual content at a baseline focal distance (e.g., 1 meter), with the first pair of dynamic push/pull lenses operable to move the focal distance of virtual content closer (e.g., 0.5 meters in the active state), and the second pair of dynamic push/pull lenses operable to move the focal distance of the virtual content farther away in the active state (e.g., farther away than 1 meter, such as at infinity or at 5 meters).

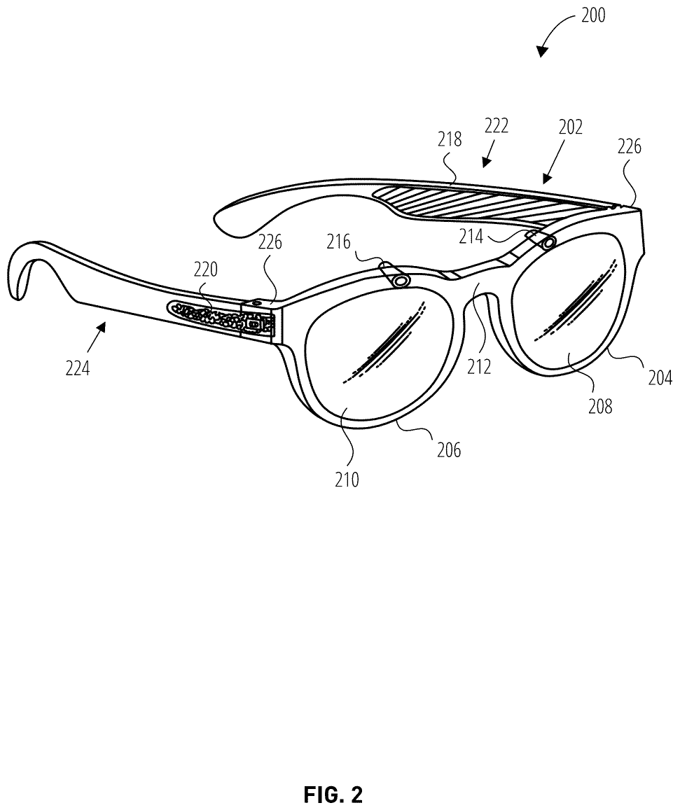

FIG. 2 is perspective view of a head-worn XR device (e.g., glasses 200) that may be used to implement some or all of the functions of XR display systems described herein. The glasses 200 can include a frame 202 made from any suitable material such as plastic or metal, including any suitable shape memory alloy. In one or more examples, the frame 202 includes a first or left optical element holder 204 (e.g., a display or lens holder) and a second or right optical element holder 206 connected by a bridge 212. A first or left optical element 208 and a second or right optical element 210 can be provided within respective left optical element holder 204 and right optical element holder 206. The right optical element 210 and the left optical element 208 can be a lens, a display, a display assembly, or a combination of the foregoing. Any suitable display assembly can be provided in the glasses 200, such as one of the assembles shown in FIG. 1A or FIG. 1B. In some examples, the optical elements 208, 210 each include an image presentation component 102 coupled to pairs of dynamic and/or static push/pull lenses, as described above.

The frame 202 additionally includes a left arm or temple piece 222 and a right arm or temple piece 224. In some examples the frame 202 can be formed from a single piece of material so as to have a unitary or integral construction.

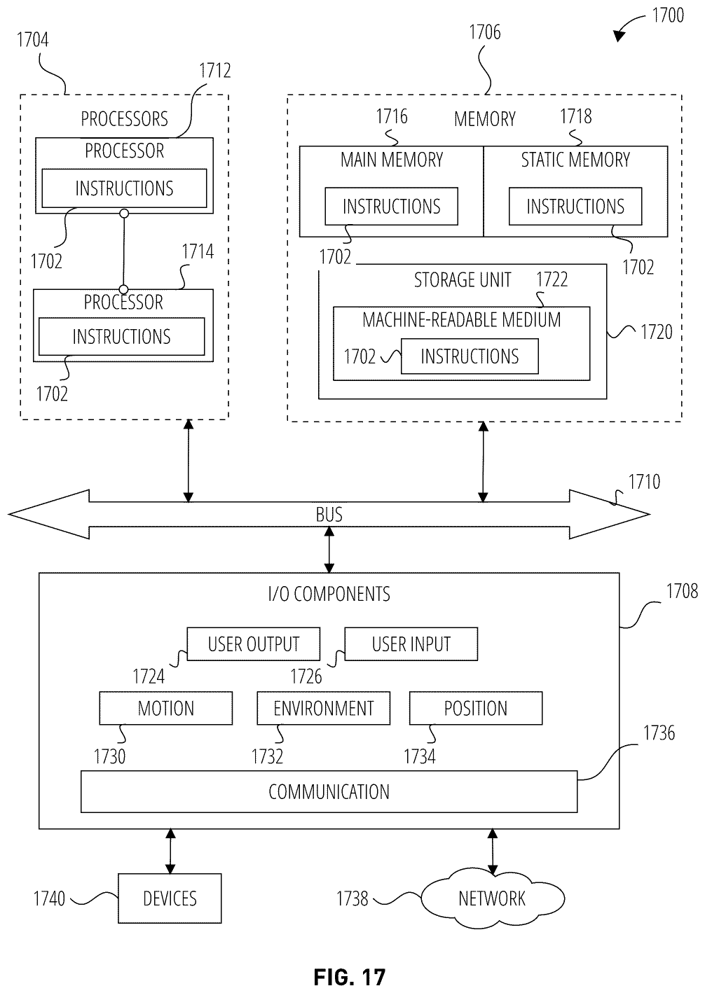

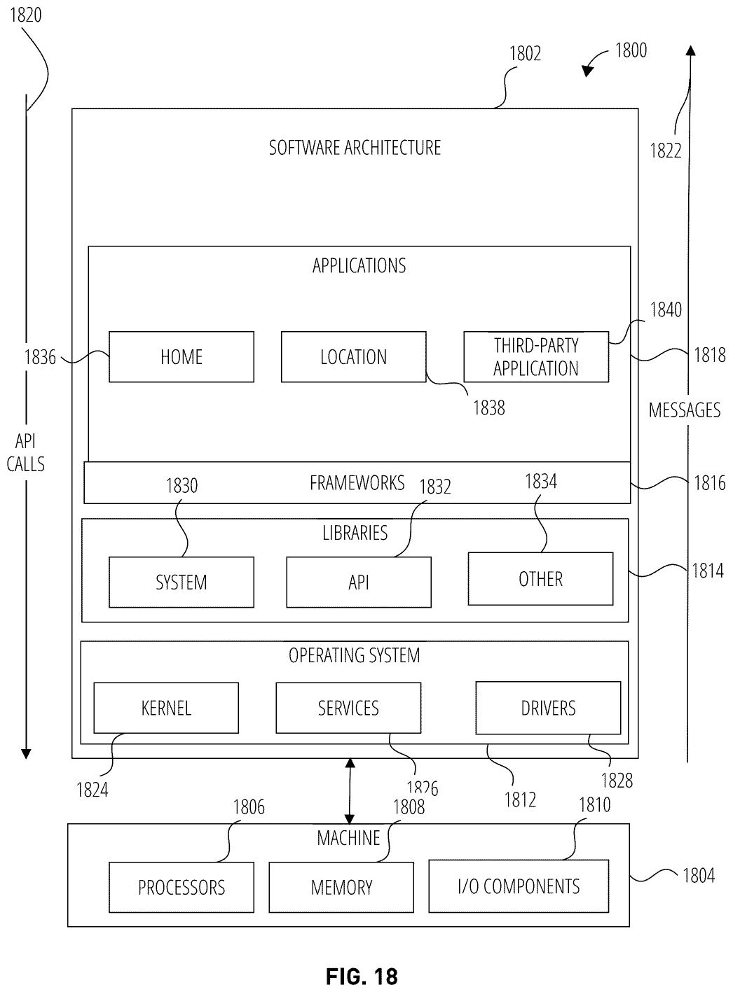

The glasses 200 can include a computing device, such as a computer 220, which can be of any suitable type so as to be carried by the frame 202 and, in one or more examples, of a suitable size and shape, so as to be partially disposed in one of the temple piece 222 or the temple piece 224. The computer 220 can include one or more processors with memory, wireless communication circuitry, and a power source. Various other examples may include these elements in different configurations or integrated together in different ways. In some examples, the computer 220 may be implemented as the example machine 1700 described below with reference to FIG. 17. In some examples, the computer 220 implements all or part of the software architecture 1802 described below with reference to FIG. 18.

The computer 220 additionally includes a battery 218 or other suitable portable power supply. In some examples, the battery 218 is disposed in left temple piece 222 and is electrically coupled to the computer 220 disposed in the right temple piece 224. The glasses 200 can include a connector or port (not shown) suitable for charging the battery 218, a wireless receiver, transmitter or transceiver (not shown), or a combination of such devices.

The glasses 200 include a first or left camera 214 and a second or right camera 216. Although two cameras are depicted, other examples contemplate the use of a single camera or more than two cameras. In one or more examples, the glasses 200 include any number of input sensors or other input/output devices in addition to the left camera 214 and the right camera 216, such as one or more optical calibration sensors, eye tracking sensors, ambient light sensors, and/or environment sensors. Such sensors or input/output devices can additionally include location sensors, motion sensors, and so forth. It will be appreciated that the cameras 214, 216 are a form of optical sensor, and that the glasses 200 may include additional types of optical sensors in some examples.

One or more buttons 226 may be placed on the temple piece 222 and/or temple piece 224 to provide user input to the computer 220.

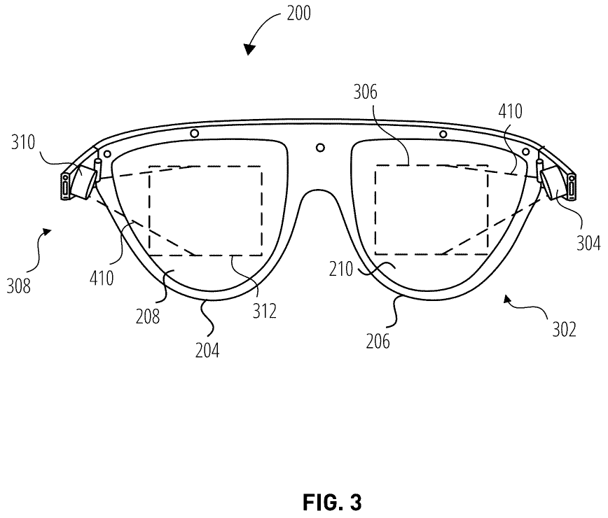

FIG. 3 illustrates the glasses 200 from the perspective of a user. For clarity, a number of the elements shown in FIG. 2 have been omitted. As described in FIG. 2, the glasses 200 shown in FIG. 3 include left optical element 208 and right optical element 210 secured within the left optical element holder 204 and the right optical element holder 206 respectively.

The glasses 200 include right forward optical assembly 302 comprising a right projector 304 and a right image presentation component 306, and a left forward optical assembly 308 including a left projector 310 and a left image presentation component 312. The right forward optical assembly 302 may also be referred to herein, by itself or in combination with one or both of the respective optical elements 208 and 210, and/or in combination with the static push lenses 108, static pull lenses 110, dynamic push lenses 112, and/or dynamic pull lenses 114, as a near-eye optical see-through XR display.

In some examples, the image presentation components 306 are waveguides. The waveguides include reflective or diffractive structures (e.g., gratings and/or optical elements such as mirrors, lenses, or prisms). Projected light 410 emitted by the projector 304 encounters the diffractive structures of the waveguide of the image presentation component 306, which directs the light towards the right eye of a user to provide an image on or in the right optical element 210 that overlays the view of the real world seen by the user. Similarly, projected light 410 emitted by the projector 310 encounters the diffractive structures of the waveguide of the image presentation component 312, which directs the light towards the left eye of a user to provide an image on or in the left optical element 208 that overlays the view of the real world seen by the user. The combination of a GPU, the right forward optical assembly 302, the left optical element 208, and the right optical element 210 provide an optical engine of the glasses 200. The glasses 200 use the optical engine to generate an overlay of the real world view of the user including display of a 3D user interface to the user of the glasses 200. The surface of the optical element 208 or 210 from which the projected light exits toward the user's eye is referred to as a user-facing surface or an image presentation surface on the eye-facing side of the near-eye optical see-through XR display.

It will be appreciated that other display technologies or configurations may be utilized within an optical engine to display an image to a user in the user's field of view. For example, instead of a projector 304 and a waveguide, an LCD, LED or other substantially transparent display panel or surface may be provided.

In use, a user of the glasses 200 will be presented with information, content and various 3D user interfaces on the near eye displays. As described in more detail herein, the user can then interact with the glasses 200 using the buttons 226, voice inputs or touch inputs on an associated device, and/or hand movements, locations, and positions detected by the glasses 200.

In some examples, one or more further optical lenses may be used to adjust the presentation of the virtual content to the user's eye, as described above. In some examples, one or more of the static and/or dynamic lenses on the eye-facing side 106 of the image presentation component 102, as described above, may be modified or supplemented with one or more additional lenses to allow users needing visual correction to correctly perceive the virtual content. Thus, for example, the static pull lens 110 and/or dynamic pull lens 114 may be modified based on an ophthalmic prescription for the user's corrective lenses to further apply optical power needed for a specific user's vision correction. In some examples, the static and/or dynamic push/pull lenses, and/or other lenses included in the glasses 200, may be controlled or manufactured to provide different degrees or types of optical power for the left and right eyes, in order to correct for an individual's optical irregularities and/or to achieve certain asymmetric optical effects between the left and right eyes.

It will be appreciated that examples described herein can be combined with various XR display designs.

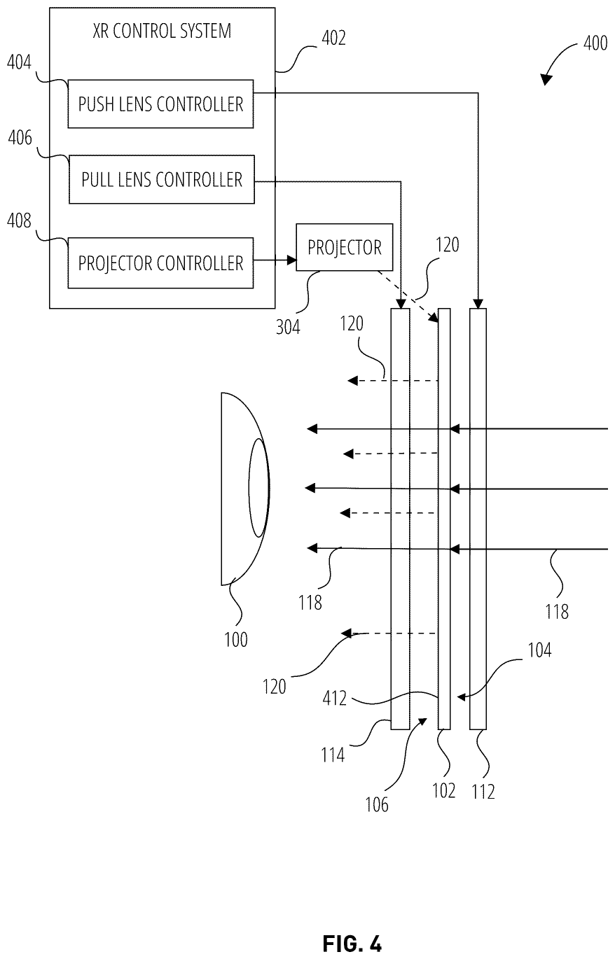

FIG. 4 is a simplified cross-sectional view of an example near-eye optical see-through XR display 400 having dynamic push/pull lenses. The near-eye optical see-through XR display 400 includes an XR control system 402 used to control the projector (shown as projector 304), the dynamic push lens 112, and the dynamic pull lens 114. In some examples, the XR control system 402 is communicatively coupled to the computer 220, which provides the virtual visual content to be projected by the projector 304, and also provides control signals for controlling the dynamic push lens 112 and dynamic pull lens 114.

It will be appreciated that, for the sake of simplicity, the beams of light shown in FIG. 4 are not shown as being bent when passing through the dynamic push lens 112 and dynamic pull lens 114. This may be taken as representing the passage of light when the dynamic push lens 112 and dynamic pull lens 114 are in the inactive state.

As shown in FIG. 4, the environmental light 118 passes through the dynamic push lens 112, then through the image presentation component 102, and finally through the dynamic pull lens 114 before reaching the eye 100. The projector 304 projects the projected light 120 into the image presentation component 102, which propagates through or across the image presentation component 102 until it is directed out of the image presentation surface 412 on the eye-facing side 106 of the image presentation component 102, through the dynamic pull lens 114, toward the eye 100.

The XR control system 402 includes a projector controller 408 for providing signals to the projector 304 effective to control the projection of the projected light 120 such that the virtual visual content is presented to the eye 100. The XR control system 402 also includes a push lens controller 404 for switching or modulating the state of the dynamic push lens 112, and a pull lens controller 406 for switching or modulating the state of the dynamic pull lens 114. In some examples, the XR control system 402 may operate at least in part based on eye tracking data received from an eye tracking system (not shown), in order to determine the gaze direction of each of the user's eyes and thereby determine the depth and direction at which the user's eyes are fixating. This eye fixation information may be used to control the operation of the dynamic push/pull lenses to improve visibility and user comfort. In some examples, an eye tracking system may be incorporated into the XR display system, such as the glasses 200, using one or more eye tracking sensors (e.g., one or more active and/or passive infrared optical sensors mounted to the frame 202) to generate gaze direction data for each eye. The gaze direction data may be processed (e.g., by computer 220) to generate eye fixation information representative of a three-dimensional location of the user's gaze fixation (e.g., the location of intersection 512 within a three-dimensional coordinate space). The depth of the intersection 512 may be determined by processing the eye fixation information, and this depth value may be used as the vergence distance 514 to control the dynamic push lens 112 and dynamic pull lens 114.

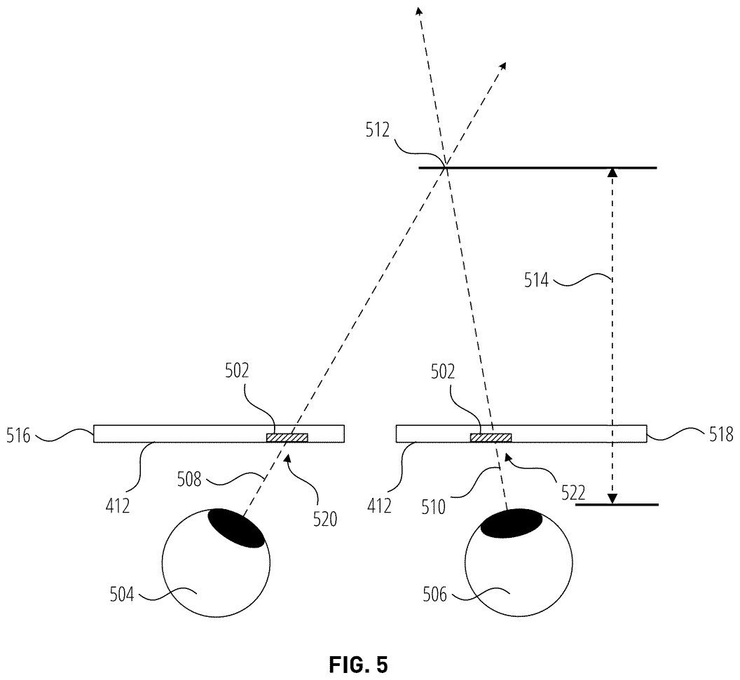

FIG. 5 illustrates a binocular pair of near-eye optical see-through XR displays (left near-eye optical see-through XR display 516 and right near-eye optical see-through XR display 518) presenting virtual visual content to a pair of eyes (left eye 504 and right eye 506). Virtual visual content 502 is presented on a first location 520 on the image presentation surface 412 of the left near-eye optical see-through XR display 516, causing the left eye 504 to rotate to an angle shown by left gaze direction 508 when fixated on the virtual visual content 502. The virtual visual content 502 is presented on a second location 522 on the image presentation surface 412 of the right near-eye optical see-through XR display 518, causing the right eye 506 to rotate to an angle shown by right gaze direction 510 when fixated on the virtual visual content 502.

The left gaze direction 508 and right gaze direction 510 intersect at intersection 512, resulting in a vergence distance 514 of the eyes. This typically causes the user's depth perception system to perceive the virtual visual content 502 as being at a distance approximately equal to the vergence distance 514. As described above, there may be benefits to providing an XR display system that can modulate the focal distance to reduce discomfort and improve visual realism over a range of vergence distances.

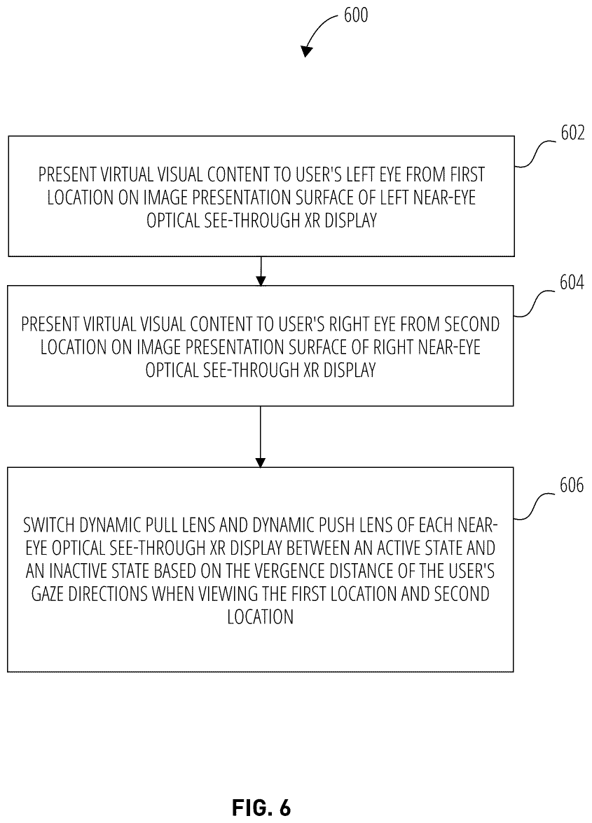

FIG. 6 is a flowchart showing operations of a method 600 for switching between activation states of dynamic push/pull lenses of an XR display system based on displaying virtual visual content at a given intended depth.

Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

The method 600 is described as being implemented by an XR display system having near-eye optical see-through XR displays 400 for each eye including dynamic push/pull lenses, and having a computer 220 and/or XR control system 402, as described above with reference to FIG. 1B, FIG. 2, and FIG. 4. However, it will be appreciated that the operations of method 600 can be implemented or performed, in some cases, by other suitable systems or devices.

According to some examples, the method 600 includes presenting virtual visual content 502 to a user's left eye 504 from first location 520 on an image presentation surface 412 of a left near-eye optical see-through XR display 516 at operation 602.

According to some examples, the method 600 includes presenting the virtual visual content 502 to a user's right eye 506 from a second location 522 on an image presentation surface 412 of a right near-eye optical see-through XR display 518 at operation 604.

According to some examples, the method 600 includes switching a dynamic pull lens 114 and a dynamic push lens 112 of each near-eye optical see-through XR display (e.g., 516 and 518) between an active state and an inactive state based on the vergence distance 514 of the user's gaze directions (e.g., 508 and 510) when viewing the first location 520 and second location 522, at operation 606. In some examples, as described above, the vergence distance 514 may be determined based on eye fixation information received from an eye tracking system of the XR display system. Thus, in some examples, the XR display system may determine the gaze directions of the user's eyes, and thereby determine whether the eyes are viewing the first location 520 and second location 522, based at least in part on eye tracking data.

In some examples, the dynamic pull lens 114 and dynamic push lens 112 of each near-eye optical see-through XR display can be switched to the active state when the vergence distance 514 falls below an activation vergence threshold (e.g., when the vergence distance falls below an activation vergence threshold of 0.6 meters for the switchable 1D/2D example described above).

In some examples, the dynamic pull lens 114 and dynamic push lens 112 of each near-eye optical see-through XR display can be switched to the inactive state when the vergence distance 514 rises above an inactivation vergence threshold (e.g., when the vergence distance rises above an inactivation vergence threshold of 0.7 meters for the switchable 1D/2D example described above). In some examples, the activation vergence threshold and inactivation vergence threshold are the same. In some examples, the dynamic push lens 112 and dynamic pull lens 114 are switchable between more than two states, and multiple activation vergence threshold and inactivation vergence threshold values may be used. In some examples, the dynamic push lens 112 and dynamic pull lens 114 can vary the focal distance across a continuous range of values, and the focal distance is set to a value within the range based on the vergence distance, e.g., based on a mathematical relationship between the vergence distance and the focal distance (such as a closest fit between focal distance and vergence distance).

In some examples, the dynamic push lens 112 and dynamic pull lens 114 may be used to achieve different effects than simply assisting the display of virtual content at an intended focal distance. For example, the dynamic push lens 112 and dynamic pull lens 114 may be configured to achieve effects such as magnification of a portion of the real-world visual field, or to achieve a mismatch between the optical power of the dynamic push lens 112 and dynamic pull lens 114 in situations when the user is attending exclusively to virtual content and wants to “blur out” or otherwise decrease the visibility of the real-world visual field.

In some examples, the left and right dynamic lenses may apply different degrees of optical power based on the left or right direction of the virtual visual content. For example, when the virtual visual content is presented to the right side of the user's field of view (as in FIG. 5), the right dynamic pull lens 114 may apply optical power of slightly lower magnitude than −1D (e.g., −0.9D), while the left dynamic pull lens 114 applies −1D or slightly greater magnitude (e.g., −1.1D) in order to compensate for the slight difference in perceived distance of the virtual visual content from each eye.

Other applications of dynamic push/pull lenses will be apparent to a skilled person in the field of near-eye optical see-through XR displays.

FIG. 7 through FIG. 16 show examples of liquid crystal cells used to implement the dynamic push lens 112 and/or dynamic pull lens 114, potentially addressing technical challenges relating to LC alignment, LC response, and light polarization.

FIG. 7 illustrates a front view of a first liquid crystal cell 700 showing parallel liquid crystal alignment directions 702 across a surface of the liquid crystal cell 700. Liquid crystals inside a liquid crystal cell 700 are often aligned using techniques such as photoalignment or rub alignment. Photoalignment is often preferred in contexts where there is a risk of damage to the cell surface, or where highly precise small-scale alignment is required, because masking techniques such as photolithography can be used to create highly precise, small-scale patterns of liquid crystal alignment at different locations across the surface of the LC cell. Alignment functions to align the oblong liquid crystals to orient their longitudinal axis in a common direction, such that they respond in a predictable way to stimuli that causes them to change their orientation, thereby causing predictable changes to light passing through the LC cell at that location.

Some examples described herein may use a pattern of concentric ring electrodes 704 sharing a common center 716 to apply an electrical stimulus through a surface of the liquid crystal cell 700, thereby causing the liquid crystals within the liquid crystal cell 700 to reorient their longitudinal axes in accordance with an electrical field generated within the liquid crystal cell 700 by the electrical stimulus. In the illustrated example, the ring electrodes 704 generate electrical fields that are radially directional, radiating outward from the common center 716: this results in different orientations of the electrical fields at different locations across the surface of the liquid crystal cell 700, including parallel electrical fields 706 that are parallel to the LC alignment direction 702, perpendicular electrical fields 708 that are perpendicular to the alignment direction 702, and oblique electrical fields 710 that are transversely diagonal or oblique to the alignment direction 702.

FIG. 7 is shown in an x/y plane defined by an x axis 712 and a y axis 714, with a z axis extending into and out of the plane of the drawing (and through a depth or thickness of the liquid crystal cell 700). The alignment direction 702 in this example is parallel to the x axis 712.

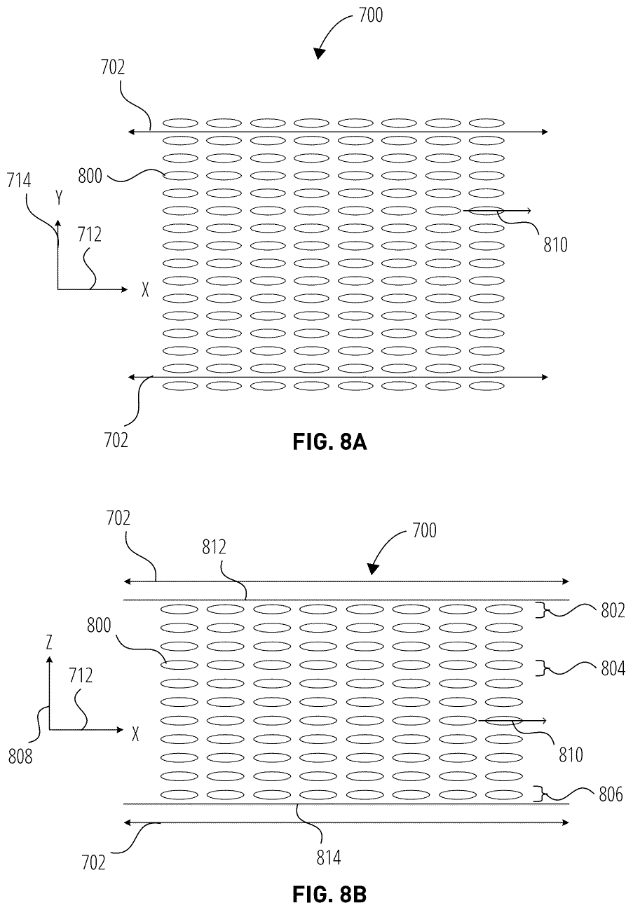

FIG. 8A illustrates a magnified front view of the liquid crystal cell 700, showing alignment of individual liquid crystals 800 across the x/y surface. The individual liquid crystals 800 each have a longitudinal axis 810 aligned parallel to the alignment direction 702 and to the x axis 712. This alignment may be achieved using photoalignment, rub alignment, or another suitable liquid crystal alignment technique.

FIG. 8B illustrates a magnified side cross-sectional view of the liquid crystal cell 700, defined by the z axis 808 and the x axis 712, showing alignment of individual liquid crystals 800 within layers stacked depth-wise along the z axis 808 between a first surface 812 and a second surface 814 of the liquid crystal cell 700. In some examples, the ring electrodes 704 of FIG. 7 may be applied to the first surface 812.

The layers of liquid crystals 800 include a first layer 802 adjacent to the first surface 812, a final layer 806 adjacent to the second surface 814, and a series of intermediate layers 804 successively stacked between the first layer 802 and final layer 806. In this illustrated example, corresponding to the uniformly aligned liquid crystal cell 700 of FIG. 7, each of the layers 802, 804, and 806 has the same alignment.

Returning to the view of FIG. 7, problems of non-uniform liquid crystal response can arise when the relative angles of the alignment direction 702 and the electrical field differ at different locations across the surface of the liquid crystal cell 700. For example, the locations having an oblique electrical field 710 may exhibit undesired in-plane twisting or rotation of the liquid crystals in response to the electrical stimulus, resulting in different optical effects being applied in these regions than in the regions having a parallel electrical field 706 or a perpendicular electrical field 708. In some cases, even the regions having a perpendicular electrical field 708 may differ in their LC response relative to the regions having a parallel electrical field 706. Specifically, the non-uniform LC response may result in unintended variation in refractive index tangential to the ring electrodes 704.

Accordingly, various examples described herein may attempt to improve the homogeneity of the LC response, and therefore the optical effects applied to light, of these different regions of the liquid crystal cell 700.

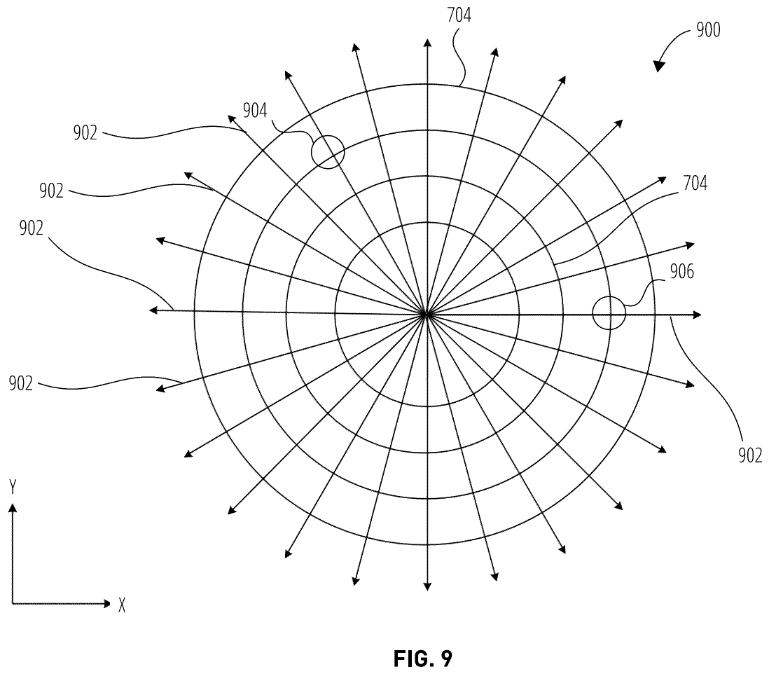

FIG. 9 illustrates a front view of a second liquid crystal cell 900 showing radial liquid crystal alignment directions across a surface of the liquid crystal cell 900. By aligning the liquid crystals of the liquid crystal cell 900 radially (shown as radial alignment directions 902), and therefore parallel to the electrical field induced by the ring electrodes 704, a uniform liquid crystal response can be ensured, therefore potentially improving the uniform optical properties of the liquid crystal cell 900. The pattern of radial alignment directions 902 shown in FIG. 9 can be created by techniques such as photoalignment using photolithography during the fabrication of the dynamic push lens 112 and dynamic pull lens 114.

By ensuring that the angle between the electrical field and the radial alignment direction 902 is the same in each location across the surface of the liquid crystal cell 900 (in this case, 0 degrees difference), the liquid crystal cell 900 show in FIG. 9 ensures that any two columnar regions defining a columnar sample through the layers of liquid crystals 800 extending between the first surface 812 and second surface 814 of the liquid crystal cell 900 (e.g., first columnar region 904 and second columnar region 906) exhibit the same relationship between the radial alignment direction 902 and the direction of the electrical field: in this case, each columnar region will have a parallel electrical field 706 parallel to the radial alignment direction 902.

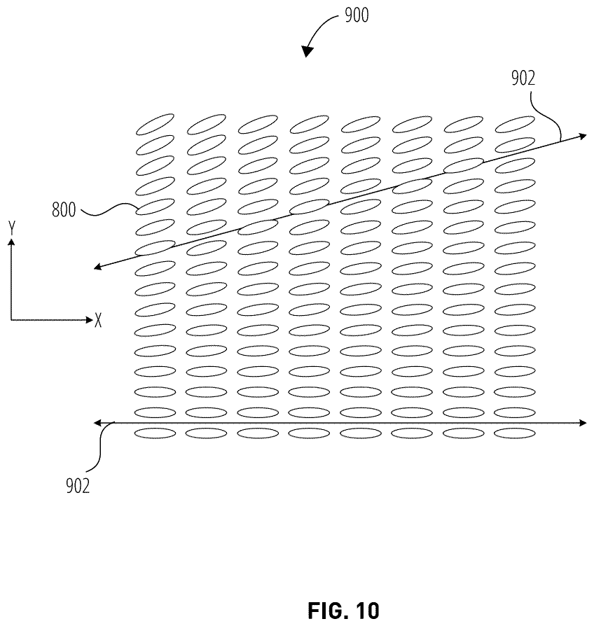

FIG. 10 illustrates a magnified front view of the liquid crystal cell 900 of FIG. 9, showing alignment of individual liquid crystals across the surface. The individual liquid crystals 800 align to the closest radial alignment direction 902, and in some cases may form a continuous directional gradient in between the two illustrated radial alignment directions 902. It will be appreciated that other alignment patterns described herein that have non-parallel alignment directions may exhibit similar patterns of alignment of individual liquid crystals 800 as those shown in FIG. 10.

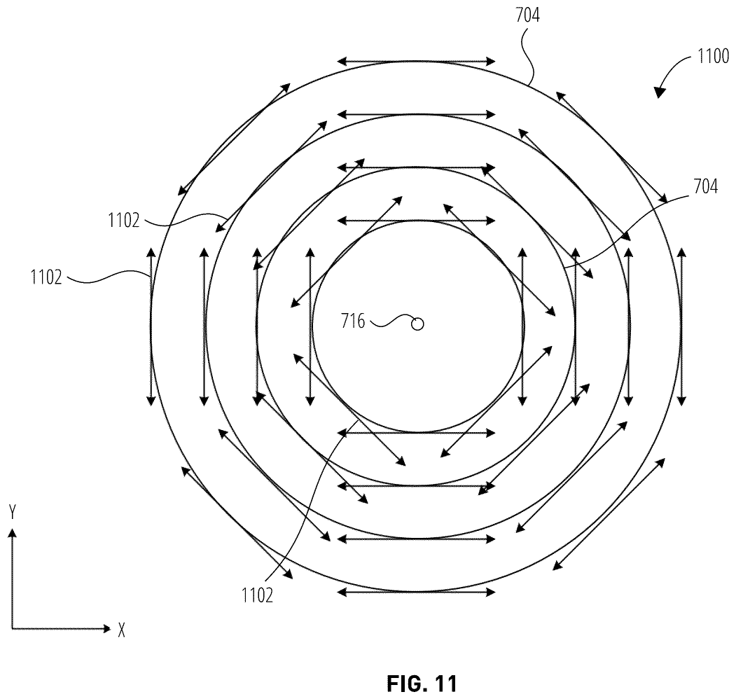

FIG. 11 illustrates a front view of a third liquid crystal cell 1100 showing circular alignment directions 1102 of the liquid crystals 800 across a surface of the liquid crystal cell 1100. In this example, the liquid crystals 800 are aligned to be perpendicular to the electrical field at each location across the surface of the liquid crystal cell 1100, by aligning the liquid crystals 800 in circular alignment directions 1102 tangential to concentric circles centered on the common center 716. In this case, each columnar region of the liquid crystal cell 1100 will have a perpendicular electrical field 708 perpendicular to the circular alignment direction 1102.

In some cases, the dynamic push lens 112 and dynamic pull lens 114 are configured to receive and transform light having a non-uniform or unknown polarization. This requires both lenses to be able to apply their optical power to light of arbitrary polarization, which can be difficult for a single LC cell having a uniform LC alignment. One possible approach to addressing the problem of polarization-independence is to use two different LC cells for each lens (e.g., two LC cells for the dynamic push lens 112 and two LC cells for the dynamic pull lens 114), each LC cell of each pair being aligned orthogonally to its paired counterpart. For example, a dynamic push lens 112 could use a first LC cell having the parallel alignment of the liquid crystal cell 700 of FIG. 7, in which the liquid crystals 800 are aligned parallel to the x axis 712, paired with a second LC cell having liquid crystals 800 aligned parallel to the y axis 714.

However, in order to address both the non-uniform LC response problem and the polarization-independence problem, some examples may instead implement the dynamic push lens 112 and/or dynamic pull lens 114 using a first LC cell aligned as per liquid crystal cell 900, paired with a second LC cell aligned as per liquid crystal cell 1100.

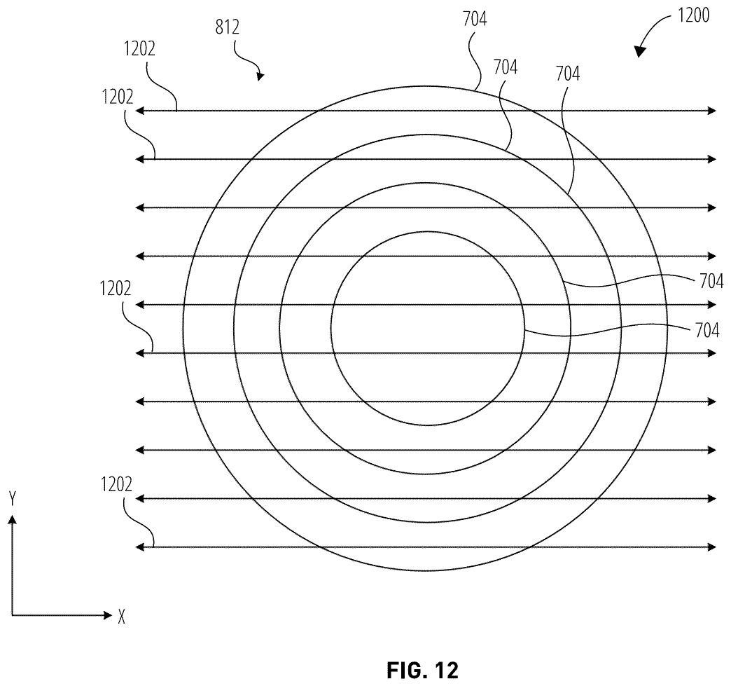

Other examples may attempt to address the non-uniform LC response problem and the polarization-independence problem by using a single LC cell to implement each dynamic lens, by applying one or more of the techniques described below with reference to FIG. 12 through FIG. 14D.

In a first example technique, twisted nematic liquid crystals may be used in the LC cell to achieve a vertical distribution (along the z axis 808 extending through the layers of liquid crystals 800) of different orientations of the liquid crystals 800. A quarter-turn (90 degree) twist in orientation between the first surface 812 and second surface 814 of the LC cell will provide, at each columnar region across the surface of the LC cell, a uniform distribution of liquid crystal 800 orientations, thereby homogenizing the LC response to a directional electrical field and homogenizing the refractive index created by birefringence regardless of the polarization of the light passing through the LC cell.

FIG. 12 illustrates a front view of a fourth liquid crystal cell 1200 showing parallel liquid crystal alignment in a first direction 1202 across a first surface 812 of the liquid crystal cell 1200. The liquid crystal cell 1200 is filled with twisted nematic liquid crystals having an alignment in the first direction 1202 at the first surface. The twisted nematic alignment of the liquid crystals 800 within the liquid crystal cell 1200 may be achieved using known techniques for fabricating twisted nematic liquid crystal cells.

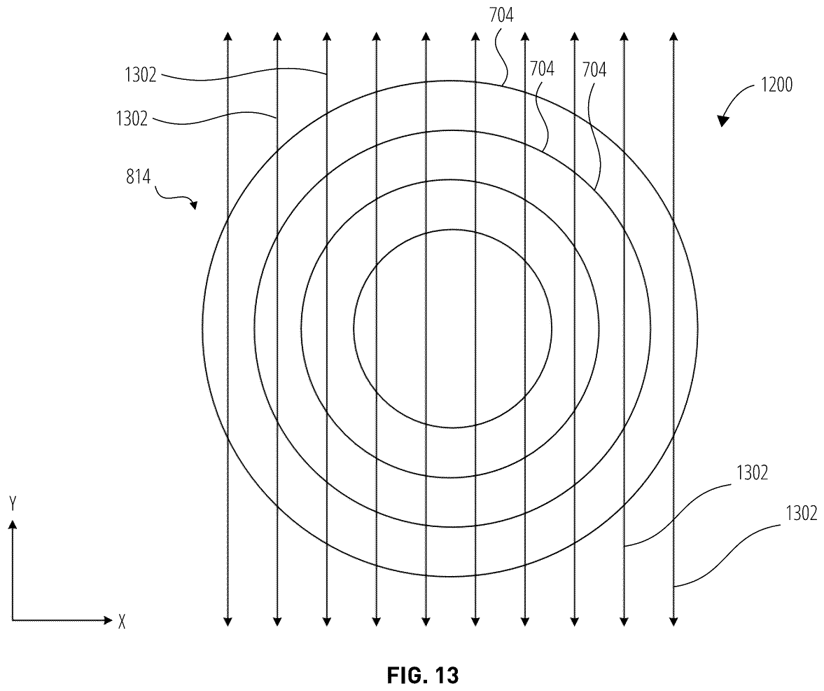

FIG. 13 illustrates a rear view of the fourth liquid crystal cell 1200 of FIG. 12, showing parallel liquid crystal alignment in a second direction 1302 across a second surface 814 of the liquid crystal cell 1200.

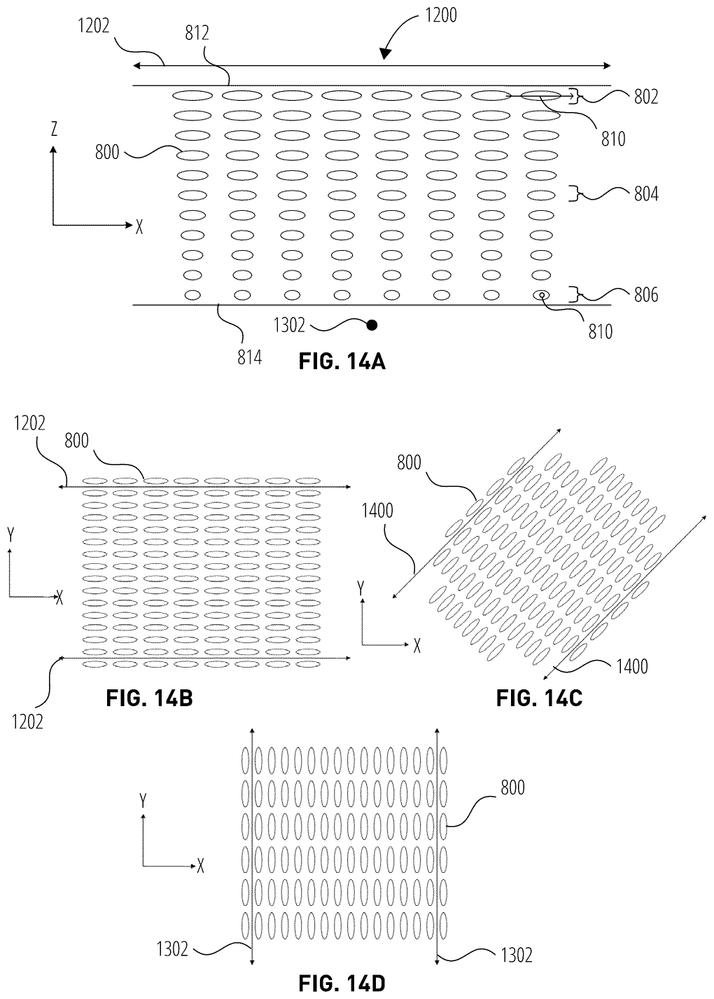

FIG. 14A illustrates a magnified side cross-sectional view of the liquid crystal cell 1200 of FIG. 12 and FIG. 13, showing alignment of individual liquid crystals 800 within layers stacked depth-wise. As can be seen, whereas the longitudinal axis 810 of the liquid crystals 800 in the first layer 802 are parallel to the first direction 1202 and to the x axis 712, the longitudinal axis 810 rotates within the x-y plane at each successive intermediate layer 804 until the liquid crystals 800 of the final layer 806 have a longitudinal axis 810 projecting out of the drawing, parallel to the second direction 1302 and to the y axis 714. The twisted-nematic liquid crystal material, when not driven, is in a high refractive index state as seen from above. When the twisted-nematic liquid crystal material is driven, it changes to a low refractive index state. Those two states, and the states in between, are used to vary the refractive index through the LC cell and create the desired optical path difference. It will be appreciated that the examples described above in FIGS. 8A-8B and FIG. 10 illustrate the liquid crystal material in linear ECB states.

This progressive rotation of 90 degrees between the first surface 812 and 814 is further illustrated in FIG. 14B through FIG. 14D.

FIG. 14B illustrates a magnified front cross-sectional view of a first layer 802 of the liquid crystal cell 1200 of FIG. 12 and FIG. 13, showing alignment of individual liquid crystals 800 within the layer parallel to the first direction 1202.

FIG. 14C illustrates a magnified front cross-sectional view of an intermediate layer 804 of the liquid crystal cell 1200 of FIG. 12 and FIG. 13, showing alignment of individual liquid crystals 800 within the layer parallel to an intermediate direction 1400 intermediate between the first direction 1202 and second direction 1302.

FIG. 14D illustrates a magnified front cross-sectional view of a final layer 806 of the liquid crystal cell 1200 of FIG. 12 and FIG. 13, showing alignment of individual liquid crystals 800 within the layer parallel to the second direction 1302.

Thus, the liquid crystal cell 1200 described above attempts to address the non-uniform LC response problem and the polarization-independence problem by using twisted nematic liquid crystals distributed between a first parallel alignment and a second parallel alignment orthogonal to the first alignment. The example liquid crystal cell 1200 is potentially easier to fabricate than other approaches, as its parallel alignment patterns of twisted nematic liquid crystals could potentially be achieved through rub alignment instead of the relatively much more resource-intensive process of photoalignment.

Other examples may alter the arrangement of twisted nematic liquid crystals: for example, an LC cell could be used that has twisted nematic liquid crystals aligned on the first surface 812 in a radial alignment pattern as per liquid crystal cell 900, and twisted 90 degrees into a concentric circular alignment pattern as per liquid crystal cell 1100 at the second surface 814.

In some examples, a chiral component may be added to the liquid crystal material to enhance the directional independence of the LC response regardless of light polarization and/or electrical field direction. Chirality imparts an asymmetric helical structure to the liquid crystals 800 and may cause them to refract light and/or mechanically respond to electrical fields of multiple orientations of directionality and/or polarity. An LC cell using chiral liquid crystals may be effective to increase a homogeneity of the liquid crystal response to the electrical stimulus across the surface of the LC cell, regardless of the alignment of the LC cell. Because a simple parallel alignment configuration could be used with chiral liquid crystals (such as the alignment pattern of liquid crystal cell 700), examples using chiral liquid crystals may also be relatively easy to fabricate.

Each of these techniques may be used, alone or in combination, to improve the polarization-independence and/or uniformity of LC response, of the dynamic push lens 112 and/or dynamic pull lens 114 in examples described herein.

An additional complication may arise in some examples relating to visual artifacts created by a Fresnel pattern of the dynamic push lens 112 and/or the dynamic pull lens 114.

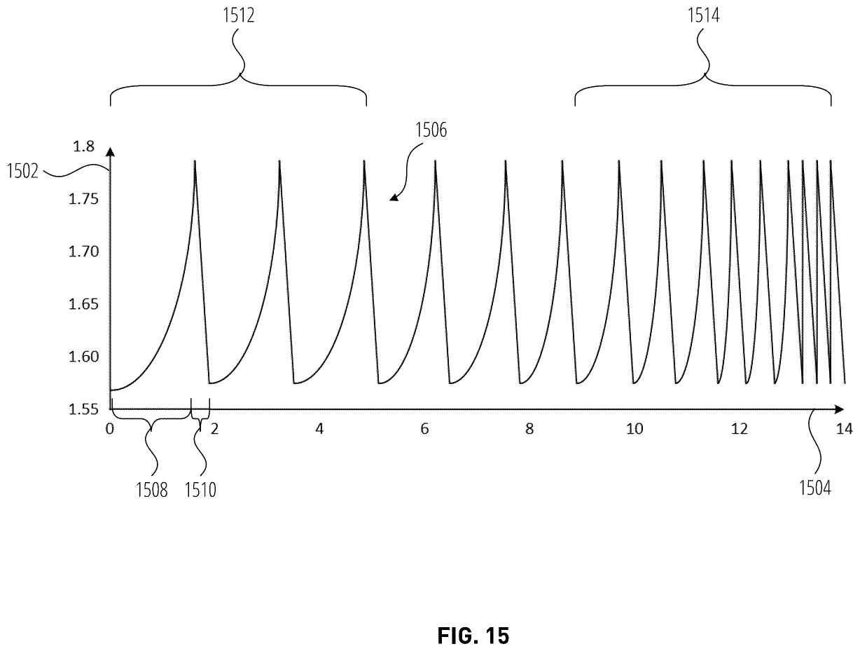

FIG. 15 illustrates a graph of refractive index across a surface of an example Fresnelized Gradient Index (GRIN) lens. The refractive index 1502 of the LC cell is shown as the vertical axis, and a radial distance 1504 from the center of the lens (in mm) is shown as the horizontal axis.

In some examples, the dynamic push lens 112 and the dynamic pull lens 114 are implemented as Fresnelized GRIN lenses. Each dynamic lens has a Fresnel pattern 1506 of modulated refractive index across its surface, comprising multiple Fresnel zones 1508 of gradually increasing (or gradually decreasing) refractive index, separated from each adjacent Fresnel zone by a reset zone 1510 having a sharply falling (or rising) refractive index. The Fresnel pattern is effective to achieve divergence or convergence of light within a relatively narrow band of refractive index values achievable by the LC cell.

The ring electrodes 704 are spaced periodically across the radial distance 1504 to apply a spatially modulated voltage, thereby creating the Fresnel pattern 1506 in the LC cell. In some examples, each Fresnel zone 1508 may span many ring electrodes 704, such as more than fifty or more than one hundred ring electrodes 704. However, it can be seen that the Fresnel zones 1508 decrease in size as they leave the central region 1512 of the lens and approach the peripheral region 1514 of the lens. Thus, Fresnel zones 1508 in the peripheral region 1514 may span fewer ring electrodes 704 than Fresnel zones 1508 in the central region 1512.

In some examples, the ring electrodes 704 may be formed from a transparent conductive material such as indium tin oxide (ITO) or another transparent conductive oxide (TCO). The ring electrodes 704 may each have a thickness of approximately 5 microns, and may be spaced approximately 5 microns apart from each other concentrically.

In some cases, the Fresnel pattern of refractive index modulation induced in the LC cell by the ring electrodes 704 during the active mode can result in unwanted visual artifacts due to light striking a reset zone 1510 with a steep refractive index gradient and refracting into an unintended location of the user's eye 100. In some designs of the dynamic push lens 112 and/or dynamic pull lens 114, these unwanted visual artifacts tend to become more numerous in the peripheral region 1514 of the lens, because the reset zones 1510 begin to occupy a greater proportion of the surface area of the lens relative to the Fresnel zones 1508. Thus, it may be desirable to partially or fully occlude the peripheral region 1514 of the dynamic push lens 112 and/or dynamic pull lens 114 in some examples in order to reduce the visibility of these visual artifacts without obscuring the field of view nearer the central region 1512.

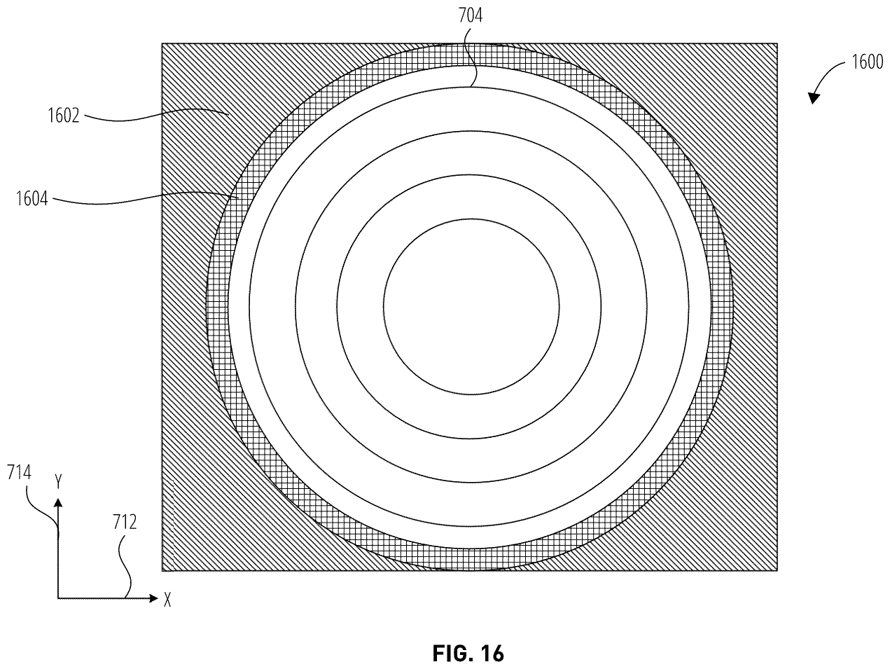

FIG. 16 illustrates a front view of a liquid crystal cell 1600 coupled to a dimmer for blocking light in a peripheral region of the lens. The liquid crystal cell 1600 uses ring electrodes 704, like the examples described above. A dimmer can be incorporated into or coupled to the lens, e.g., as a further layer of the near-eye optical see-through XR display 400. In some examples, the dimmer may be implemented as a further controllable LC cell configured to dynamically modulate an optical transmittance of the dimmer at addressable regions across the area of the dimmer.

In some examples, the dimmer is a bistable liquid crystal filter that uses bistable LC elements to dynamically control the amount of light that is propagated through the LC elements. Because bistable liquid crystal displays require low or no power draw to maintain a fixed degree of optical transmittance, some examples may use a bistable liquid crystal filter to implement the dimmer. In some examples, non-LC bistable filters may be used, such as electrochromic filters, or bistable electrophoretic materials suspending tinted particles of elements that are moved to a filtering position or orientation by application of an electrical signal. It will be appreciated that various technologies may be used to implement the dimmer in different examples.

In operation, the dimmer may be activated to decrease transmittance of light passing through an outer peripheral region 1602 of the liquid crystal cell 1600 when the liquid crystal cell 1600 is in its active state. The dimmer may also operate to decrease transmittance to a lesser degree through an inner peripheral region 1604 of the liquid crystal cell 1600 when the liquid crystal cell 1600 is in its active state. In some examples, such as examples in which the liquid crystal cell 1600 can be continuously modulated between different levels of optical power, the dimmer may operate to provide a degree of transmittance inversely proportional (or in another negative relationship) to the optical power applied by the lenses.

### Machine Architecture

FIG. 17 is a diagrammatic representation of a machine 1700 within which instructions 1702 (e.g., software, a program, an application, an applet, an app, or other executable code) for causing the machine 1700 to perform any one or more of the methodologies discussed herein may be executed. For example, the instructions 1702 may cause the machine 1700 to execute any one or more of the methods described herein, and the machine 1700 may be used to implement some or all of the computational functions of the example XR display systems described herein, e.g., the functions of the computer 220 of the glasses 200 of FIG. 2. The instructions 1702 transform the general, non-programmed machine 1700 into a particular machine 1700 programmed to carry out the described and illustrated functions in the manner described. The machine 1700 may operate as a standalone device or may be coupled (e.g., networked) to other machines. In a networked deployment, the machine 1700 may operate in the capacity of a server machine or a client machine in a server-client network environment, or as a peer machine in a peer-to-peer (or distributed) network environment. The machine 1700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch, a pair of augmented reality glasses), a smart home device (e.g., a smart appliance), other smart devices, a web appliance, a network router, a network switch, a network bridge, or any machine capable of executing the instructions 1702, sequentially or otherwise, that specify actions to be taken by the machine 1700. Further, while a single machine 1700 is illustrated, the term “machine” shall also be taken to include a collection of machines that individually or jointly execute the instructions 1702 to perform any one or more of the methodologies discussed herein. In some examples, the machine 1700 may comprise both client and server systems, with certain operations of a particular method or algorithm being performed on the server-side and with certain operations of the particular method or algorithm being performed on the client-side.

The machine 1700 may include processors 1704, memory 1706, and input/output I/O components 1708, which may be configured to communicate with each other via a bus 1710. In an example, the processors 1704 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1712 and a processor 1714 that execute the instructions 1702. The term “processor” is intended to include multi-core processors that may comprise two or more independent processors (sometimes referred to as “cores”) that may execute instructions contemporaneously. Although FIG. 17 shows multiple processors 1704, the machine 1700 may include a single processor with a single-core, a single processor with multiple cores (e.g., a multi-core processor), multiple processors with a single core, multiple processors with multiples cores, or any combination thereof.

The memory 1706 includes a main memory 1716, a static memory 1718, and a storage unit 1720, all accessible to the processors 1704 via the bus 1710. The main memory 1706, the static memory 1718, and the storage unit 1720 store the instructions 1702 embodying any one or more of the methodologies or functions described herein. The instructions 1702 may also reside, completely or partially, within the main memory 1716, within the static memory 1718, within machine-readable medium 1722 within the storage unit 1720, within at least one of the processors 1704 (e.g., within the processor's cache memory), or any suitable combination thereof, during execution thereof by the machine 1700.

The I/O components 1708 may include a wide variety of components to receive input, provide output, produce output, transmit information, exchange information, capture measurements, and so on. The specific I/O components 1708 that are included in a particular machine will depend on the type of machine. For example, portable machines such as mobile phones may include a touch input device or other such input mechanisms, while a headless server machine will likely not include such a touch input device. It will be appreciated that the I/O components 1708 may include many other components that are not shown in FIG. 17. In various examples, the I/O components 1708 may include user output components 1724 and user input components 1726. The user output components 1724 may include visual components (e.g., a display such as the near-eye optical see-through XR display 400, a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1726 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1708 may include motion components 1730, environmental components 1732, or position components 1734, among a wide array of other components.

The motion components 1730 include acceleration sensor components (e.g., accelerometer), gravitation sensor components, rotation sensor components (e.g., gyroscope).

The environmental components 1732 include, for example, one or more externally-facing cameras (with still image/photograph and video capabilities) such as left camera 214 and right camera 216, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), depth sensors (such as one or more LIDAR arrays), or other components that may provide indications, measurements, or signals corresponding to a surrounding physical environment.

Further, the camera system of the machine 1700 may include dual rear cameras (e.g., a primary camera as well as a depth-sensing camera), or even triple, quad or penta rear camera configurations on the front and rear sides of the machine 1700. These multiple cameras systems may include a wide camera, an ultra-wide camera, a telephoto camera, a macro camera, and a depth sensor, for example.

The position components 1734 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1708 further include communication components 1736 operable to couple the machine 1700 to a network 1738 or devices 1740 via respective coupling or connections. For example, the communication components 1736 may include a network interface component or another suitable device to interface with the network 1738. In further examples, the communication components 1736 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1740 may be another machine or any of a wide variety of peripheral devices (e.g., a peripheral device coupled via a USB).

Moreover, the communication components 1736 may detect identifiers or include components operable to detect identifiers. For example, the communication components 1736 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1736, such as location via Internet Protocol (IP) geolocation, location via Wi-Fi® signal triangulation, location via detecting an NFC beacon signal that may indicate a particular location, and so forth.

The various memories (e.g., main memory 1716, static memory 1718, and memory of the processors 1704) and storage unit 1720 may store one or more sets of instructions and data structures (e.g., software) embodying or used by any one or more of the methodologies or functions described herein. These instructions (e.g., the instructions 1702), when executed by processors 1704, cause various operations to implement the disclosed examples.

The instructions 1702 may be transmitted or received over the network 1738, using a transmission medium, via a network interface device (e.g., a network interface component included in the communication components 1736) and using any one of several well-known transfer protocols (e.g., hypertext transfer protocol (HTTP)). Similarly, the instructions 1702 may be transmitted or received using a transmission medium via a coupling (e.g., a peer-to-peer coupling) to the devices 1740.

### Software Architecture

FIG. 18 is a block diagram 1800 illustrating a software architecture 1802, which can be installed on any one or more of the devices described herein. The software architecture 1802 is supported by hardware such as a machine 1804 that includes processors 1806, memory 1808, and I/O components 1810. In this example, the software architecture 1802 can be conceptualized as a stack of layers, where each layer provides a particular functionality. The software architecture 1802 includes layers such as an operating system 1812, libraries 1814, frameworks 1816, and applications 1818. Operationally, the applications 1818 invoke API calls 1820 through the software stack and receive messages 1822 in response to the API calls 1820. The XR control system 402 and at least some of the functions of the subsystems and controllers thereof may be implemented by components in one or more layers of the software architecture 1802.

The operating system 1812 manages hardware resources and provides common services. The operating system 1812 includes, for example, a kernel 1824, services 1826, and drivers 1828. The kernel 1824 acts as an abstraction layer between the hardware and the other software layers. For example, the kernel 1824 provides memory management, processor management (e.g., scheduling), component management, networking, and security settings, among other functionalities. The services 1826 can provide other common services for the other software layers. The drivers 1828 are responsible for controlling or interfacing with the underlying hardware. For instance, the drivers 1828 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1814 provide a common low-level infrastructure used by the applications 1818. The libraries 1814 can include system libraries 1830 (e.g., C standard library) that provide functions such as memory allocation functions, string manipulation functions, mathematic functions, and the like. In addition, the libraries 1814 can include API libraries 1832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1814 can also include a wide variety of other libraries 1834 to provide many other APIs to the applications 1818.

The frameworks 1816 provide a common high-level infrastructure that is used by the applications 1818. For example, the frameworks 1816 provide various graphical user interface (GUI) functions, high-level resource management, and high-level location services. The frameworks 1816 can provide a broad spectrum of other APIs that can be used by the applications 1818, some of which may be specific to a particular operating system or platform.

In an example, the applications 1818 may include a home application 1836, a location application 1838, and a broad assortment of other applications such as a third-party application 1840. The applications 1818 are programs that execute functions defined in the programs. Various programming languages can be employed to create one or more of the applications 1818, structured in a variety of manners, such as object-oriented programming languages (e.g., Objective-C, Java, or C++) or procedural programming languages (e.g., C or assembly language). In a specific example, the third-party application 1840 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1840 can invoke the API calls 1820 provided by the operating system 1812 to facilitate functionalities described herein.

### CONCLUSION

Examples described herein may address one or more technical problems associated with XR display systems by providing passive and/or dynamic push/pull lenses to modulate the focal distance of virtual visual content. In some examples, the focal distance is modulated to better match the vergence distance of the virtual visual content. In some examples, the dynamic push/pull lenses are implemented using LC cells having liquid crystals and alignment patterns intended to improve uniformity of LC response and polarization independence of the LC cells. In some examples, the push/pull lenses use a dimmer to dim a peripheral region of the lenses when in the active state in order to diminish or obscure unwanted visual artifacts generated by the peripheral region due to the Fresnelized GRIN lens pattern used to converge and/or diverge light.

Other technical features may be readily apparent to one skilled in the art from the following figures, descriptions, and claims.

Example 1 is an extended reality (XR) display system, comprising: a near-eye optical see-through XR display, comprising: an image presentation component having an eye-facing side and a world-facing side and configured to present virtual visual content to a user's eye from a plurality of locations across an image presentation surface of the eye-facing side; a dynamic push lens positioned on the world-facing side of the image presentation component, comprising a liquid crystal cell dynamically switchable by an electrical stimulus between an inactive state and an active state, the dynamic push lens being configured to, in the active state, converge environmental light approaching the image presentation component from the world-facing side, such that the dynamic push lens in the active state applies a positive optical power to the environmental light; and a dynamic pull lens positioned on the eye-facing side of the image presentation component, comprising a liquid crystal cell dynamically switchable by an electrical stimulus between an inactive state and an active state, the dynamic pull lens being configured to, in the active state, diverge light passing out of the eye-facing side of the image presentation component toward the user's eye, such that the dynamic pull lens in the active state applies a negative optical power to the light.

In Example 2, the subject matter of Example 1 includes, wherein: in the active state, the negative optical power applied by the dynamic pull lens is of equal magnitude to the positive optical power applied by the dynamic push lens.

In Example 3, the subject matter of Example 2 includes, a static push lens positioned on the world-facing side of the image presentation component, configured to converge environmental light approaching the image presentation surface from the world-facing side, such that the static push lens applies a positive optical power to the environmental light; and a static pull lens positioned on the eye-facing side of the image presentation component, configured to diverge light passing out of the eye-facing side of the image presentation surface toward the user's eye, such that the static pull lens applies negative optical power, equal in magnitude to the positive optical power of the static push lens, to the light.

In Example 4, the subject matter of Example 3 includes, wherein: the negative optical power applied by the static pull lens is −1 diopter, effective to cause the virtual visual content to be perceived at a focal distance of 1 meter by the user's eye.

In Example 5, the subject matter of Example 4 includes, wherein: the negative optical power applied by the dynamic pull lens in the active state is −1 diopter, effective with the −1 diopter negative optical power applied by the static pull lens to cause the virtual visual content to be perceived at a focal distance of 0.5 meter by the user's eye.

In Example 6, the subject matter of Examples 1-5 includes, a second dynamic pull lens positioned on the world-facing side of the image presentation component, comprising a liquid crystal cell dynamically switchable by an electrical stimulus between an inactive state and an active state, the second dynamic pull lens being configured to, in the active state, diverge environmental light approaching the image presentation surface from the world-facing side, such that the second dynamic pull lens in the active state applies a negative optical power to the environmental light; and a second dynamic push lens positioned on the eye-facing side of the image presentation component, comprising a liquid crystal cell dynamically switchable by an electrical stimulus between an inactive state and an active state, the second dynamic push lens being configured to, in the active state, converge light passing out of the eye-facing side of the image presentation surface toward the user's eye, such that the second dynamic push lens in the active state applies a positive optical power to the light.

In Example 7, the subject matter of Examples 1-6 includes, wherein: the near-eye optical see-through XR display is a left-eye display; the user's eye is a left eye; and the display system further comprises: a right-eye display comprising a second near-eye optical see-through XR display for displaying the virtual visual content to a right eye of the user.

In Example 8, the subject matter of Example 7 includes, a processor; and a memory storing instructions that, when executed by the processor, configure the XR display system to perform operations comprising: displaying the virtual visual content at respective positions on the image presentation surfaces of the left-eye display and right-eye display such that a gaze direction of the user's left eye and a gaze direction of the user's right eye intersect at a vergence distance from the user when viewing the virtual visual content on the near-eye optical see-through XR displays; and switching the dynamic pull lens and dynamic push lens of each near-eye optical see-through XR display between the active state and the inactive state based on the vergence distance.

In Example 9, the subject matter of Example 8 includes, an eye tracking system configured to generate eye tracking data; wherein the operations further comprise: processing the eye tracking data to determine the vergence distance.

In Example 10, the subject matter of Examples 8-9 includes, wherein: switching the dynamic pull lens and dynamic push lens of each near-eye optical see-through XR display between the active state and the inactive state based on the vergence distance comprises: switching the dynamic pull lens and dynamic push lens of each near-eye optical see-through XR display to the active state when the vergence distance falls below an activation vergence threshold; and switching the dynamic pull lens and dynamic push lens of each near-eye optical see-through XR display to the inactive state when the vergence distance rises above an inactivation vergence threshold.

In Example 11, the subject matter of Examples 1-10 includes, wherein: the dynamic push lens further comprises a plurality of concentric ring electrodes in contact with a first surface of the liquid crystal cell, each adjacent pair of ring electrodes being configured to apply the electrical stimulus therebetween, thereby giving rise to an electrical field within the liquid crystal cell, the electrical field being oriented radially outward from a common center of the ring electrodes; and the liquid crystal cell comprises a plurality of layers of liquid crystals stacked between the first surface and a second surface of the liquid crystal cell.

In Example 12, the subject matter of Example 11 includes, wherein: the liquid crystals of the layers are aligned such that each columnar region extending between the first surface and second surface of the liquid crystal cell has a substantially similar distribution of liquid crystals aligned at different angles to the orientation of the electrical field.

In Example 13, the subject matter of Examples 11-12 includes, wherein: the liquid crystals are aligned radially outward from the common center.

In Example 14, the subject matter of Examples 11-13 includes, wherein: the liquid crystals are aligned tangentially to circles concentric with the common center.

In Example 15, the subject matter of Examples 11-14 includes, wherein: the liquid crystal cell of the dynamic push lens is a first liquid crystal cell; the dynamic push lens further comprises a second liquid crystal cell and a second plurality of concentric ring electrodes in contact with a first surface of the second liquid crystal cell, each adjacent pair of ring electrodes being configured to apply the electrical stimulus therebetween, thereby giving rise to an electrical field within the second liquid crystal cell, the electrical field being oriented radially outward from a common center of the ring electrodes; the liquid crystals of the first liquid crystal cell are aligned radially outward from the common center of the ring electrodes of the first liquid crystal cell; and the liquid crystals of the second liquid crystal cell are aligned tangentially to circles concentric with the common center of the ring electrodes of the second liquid crystal cell.

In Example 16, the subject matter of Examples 11-15 includes, wherein: the liquid crystals are twisted nematic liquid crystals aligned such that: the liquid crystals of a first layer closest to the first surface are aligned radially outward from the common center; the liquid crystals of a final layer closest to the second surface are aligned tangentially to circles concentric with the common center; and the liquid crystals of intermediate layers successively stacked between the first layer and the final layer have alignments successively rotated between the alignment of the liquid crystals of the first layer and the alignment of the liquid crystals of the final layer.

In Example 17, the subject matter of Examples 11-16 includes, wherein: the liquid crystals are twisted nematic liquid crystals aligned such that: the liquid crystals of a first layer closest to the first surface are aligned in a first direction; the liquid crystals of a final layer closest to the second surface are aligned in a second direction orthogonal to the first direction; and the liquid crystals of intermediate layers successively stacked between the first layer and the final layer have alignments successively rotated between the first direction and the second direction.

In Example 18, the subject matter of Examples 11-17 includes, wherein: the liquid crystals comprise chiral liquid crystals configured to increase a homogeneity, across the first surface, of a liquid crystal response to the electrical stimulus.

In Example 19, the subject matter of Examples 11-18 includes, wherein: the liquid crystal cell includes a peripheral region giving rise to visual artifacts when light passes through the peripheral region and propagates to the user's eye; and the XR display system further comprises a dimming filter positioned to block at least a portion of the light passing through the peripheral region.

Example 20 is a method of dynamically adapting focal distance to vergence distance in an extended reality (XR) display system, comprising: displaying virtual visual content at respective positions on image presentation surfaces of image presentation components of a left near-eye optical see-through XR display and right near-eye optical see-through XR display of the XR display system such that a gaze direction of a user's left eye and a gaze direction of the user's right eye intersect at a vergence distance from the user when viewing the virtual visual content on the near-eye optical see-through XR displays; and switching a dynamic pull lens and a dynamic push lens of each near-eye optical see-through XR display between an active state and an inactive state based on the vergence distance, wherein: the dynamic push lens is positioned on a world-facing side of the image presentation component of the respective near-eye optical see-through XR display, the dynamic push lens comprising a liquid crystal cell dynamically switchable by an electrical stimulus between an inactive state and an active state, the dynamic push lens being configured to, in the active state, converge environmental light approaching the image presentation component from a world-facing side of the image presentation component, such that the dynamic pull lens in the active state applies a positive optical power to the environmental light; and the dynamic pull lens is positioned on an eye-facing side of the image presentation component of the respective near-eye optical see-through XR display, the dynamic pull lens comprising a liquid crystal cell dynamically switchable by an electrical stimulus between an inactive state and an active state, the dynamic pull lens being configured to, in the active state, diverge light passing out of an eye-facing side of the image presentation component toward the user's respective eye, such that the dynamic pull lens in the active state applies a negative optical power to the light.

Example 21 is a non-transitory computer-readable storage medium, the computer-readable storage medium including instructions that when executed by a processor of a system, cause the system to perform operations comprising: displaying virtual visual content at respective positions on image presentation surfaces of image presentation components of a left near-eye optical see-through XR display and right near-eye optical see-through XR display of the system such that a gaze direction of a user's left eye and a gaze direction of the user's right eye intersect at a vergence distance from the user when viewing the virtual visual content on the near-eye optical see-through XR displays; and switching a dynamic pull lens and a dynamic push lens of each near-eye optical see-through XR display between an active state and an inactive state based on the vergence distance, wherein: the dynamic push lens is positioned on a world-facing side of the image presentation component of the respective near-eye optical see-through XR display, the dynamic push lens comprising a liquid crystal cell dynamically switchable by an electrical stimulus between an inactive state and an active state, the dynamic push lens being configured to, in the active state, converge environmental light approaching the image presentation component from a world-facing side of the image presentation component, such that the dynamic pull lens in the active state applies a positive optical power to the environmental light; and the dynamic pull lens is positioned on an eye-facing side of the image presentation component of the respective near-eye optical see-through XR display, the dynamic pull lens comprising a liquid crystal cell dynamically switchable by an electrical stimulus between an inactive state and an active state, the dynamic pull lens being configured to, in the active state, diverge light passing out of an eye-facing side of the image presentation component toward the user's respective eye, such that the dynamic pull lens in the active state applies a negative optical power to the light.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

### Glossary

“Extended reality” (XR) refers, for example, to an interactive experience of a real-world environment where physical objects that reside in the real-world are “augmented” or enhanced by computer-generated digital content (also referred to as virtual content or synthetic content). XR can also refer to a system that enables a combination of real and virtual worlds, real-time interaction, and 3D registration of virtual and real objects. A user of an XR system perceives virtual content that appears to be attached to, or interacts with, a real-world physical object.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems.

What is claimed is:

1. An extended reality (XR) display system, comprising:
a near-eye optical see-through XR display, comprising:
an image presentation component having an eye-facing side and a world-facing side and configured to present virtual visual content to a user's eye from a plurality of locations across an image presentation surface of the eye-facing side;
a dynamic push lens positioned on the world-facing side of the image presentation component, comprising a liquid crystal cell dynamically switchable by an electrical stimulus between an inactive state and an active state, the dynamic push lens being configured to, in the active state, converge environmental light approaching the image presentation component from the world-facing side, such that the dynamic push lens in the active state applies a positive optical power to the environmental light; and
a dynamic pull lens positioned on the eye-facing side of the image presentation component, comprising a liquid crystal cell dynamically switchable by an electrical stimulus between an inactive state and an active state, the dynamic pull lens being configured to, in the active state, diverge light passing out of the eye-facing side of the image presentation component toward the user's eye, such that the dynamic pull lens in the active state applies a negative optical power to the light.

2. The XR display system of claim 1, wherein:
in the active state, the negative optical power applied by the dynamic pull lens is of equal magnitude to the positive optical power applied by the dynamic push lens.

3. The XR display system of claim 2, further comprising:
a static push lens positioned on the world-facing side of the image presentation component, configured to converge environmental light approaching the image presentation surface from the world-facing side, such that the static push lens applies a positive optical power to the environmental light; and
a static pull lens positioned on the eye-facing side of the image presentation component, configured to diverge light passing out of the eye-facing side of the image presentation surface toward the user's eye, such that the static pull lens applies negative optical power, equal in magnitude to the positive optical power of the static push lens, to the light.

4. The XR display system of claim 3, wherein:
the negative optical power applied by the static pull lens is −1 diopter, effective to cause the virtual visual content to be perceived at a focal distance of 1 meter by the user's eye.

5. The XR display system of claim 4, wherein:
the negative optical power applied by the dynamic pull lens in the active state is −1 diopter, effective with the −1 diopter negative optical power applied by the static pull lens to cause the virtual visual content to be perceived at a focal distance of 0.5 meter by the user's eye.

6. The XR display system of claim 1, further comprising:
a second dynamic pull lens positioned on the world-facing side of the image presentation component, comprising a liquid crystal cell dynamically switchable by an electrical stimulus between an inactive state and an active state, the second dynamic pull lens being configured to, in the active state, diverge environmental light approaching the image presentation surface from the world-facing side, such that the second dynamic pull lens in the active state applies a negative optical power to the environmental light; and
a second dynamic push lens positioned on the eye-facing side of the image presentation component, comprising a liquid crystal cell dynamically switchable by an electrical stimulus between an inactive state and an active state, the second dynamic push lens being configured to, in the active state, converge light passing out of the eye-facing side of the image presentation surface toward the user's eye, such that the second dynamic push lens in the active state applies a positive optical power to the light.

7. The XR display system of claim 1, wherein:
the near-eye optical see-through XR display is a left-eye display;
the user's eye is a left eye; and
the display system further comprises:
a right-eye display comprising a second near-eye optical see-through XR display for displaying the virtual visual content to a right eye of the user.

8. The XR display system of claim 7, further comprising:
a processor; and
a memory storing instructions that, when executed by the processor, configure the XR display system to perform operations comprising:
displaying the virtual visual content at respective positions on the image presentation surfaces of the left-eye display and right-eye display such that a gaze direction of the user's left eye and a gaze direction of the user's right eye intersect at a vergence distance from the user when viewing the virtual visual content on the near-eye optical see-through XR displays; and
switching the dynamic pull lens and dynamic push lens of each near-eye optical see-through XR display between the active state and the inactive state based on the vergence distance.

9. The XR display system of claim 8,
further comprising an eye tracking system configured to generate eye tracking data;
wherein the operations further comprise:
processing the eye tracking data to determine the vergence distance.

10. The XR display system of claim 8, wherein:
switching the dynamic pull lens and dynamic push lens of each near-eye optical see-through XR display between the active state and the inactive state based on the vergence distance comprises:
switching the dynamic pull lens and dynamic push lens of each near-eye optical see-through XR display to the active state when the vergence distance falls below an activation vergence threshold; and
switching the dynamic pull lens and dynamic push lens of each near-eye optical see-through XR display to the inactive state when the vergence distance rises above an inactivation vergence threshold.

11. The XR display system of claim 1, wherein:
the dynamic push lens further comprises a plurality of concentric ring electrodes in contact with a first surface of the liquid crystal cell, each adjacent pair of ring electrodes being configured to apply the electrical stimulus therebetween, thereby giving rise to an electrical field within the liquid crystal cell, the electrical field being oriented radially outward from a common center of the ring electrodes; and
the liquid crystal cell comprises a plurality of layers of liquid crystals stacked between the first surface and a second surface of the liquid crystal cell.

12. The XR display system of claim 11, wherein:
the liquid crystals of the layers are aligned such that each columnar region extending between the first surface and second surface of the liquid crystal cell has a substantially similar distribution of liquid crystals aligned at different angles to the orientation of the electrical field.

13. The XR display system of claim 11, wherein:
the liquid crystals are aligned radially outward from the common center.

14. The XR display system of claim 11, wherein:
the liquid crystals are aligned tangentially to circles concentric with the common center.

15. The XR display system of claim 11, wherein:
the liquid crystal cell of the dynamic push lens is a first liquid crystal cell;
the dynamic push lens further comprises a second liquid crystal cell and a second plurality of concentric ring electrodes in contact with a first surface of the second liquid crystal cell, each adjacent pair of ring electrodes being configured to apply the electrical stimulus therebetween, thereby giving rise to an electrical field within the second liquid crystal cell, the electrical field being oriented radially outward from a common center of the ring electrodes;
the liquid crystals of the first liquid crystal cell are aligned radially outward from the common center of the ring electrodes of the first liquid crystal cell; and
the liquid crystals of the second liquid crystal cell are aligned tangentially to circles concentric with the common center of the ring electrodes of the second liquid crystal cell.

16. The XR display system of claim 11, wherein:
the liquid crystals are twisted nematic liquid crystals aligned such that:
the liquid crystals of a first layer closest to the first surface are aligned radially outward from the common center;
the liquid crystals of a final layer closest to the second surface are aligned tangentially to circles concentric with the common center; and
the liquid crystals of intermediate layers successively stacked between the first layer and the final layer have alignments successively rotated between the alignment of the liquid crystals of the first layer and the alignment of the liquid crystals of the final layer.

17. The XR display system of claim 11, wherein:
the liquid crystals are twisted nematic liquid crystals aligned such that:
the liquid crystals of a first layer closest to the first surface are aligned in a first direction;
the liquid crystals of a final layer closest to the second surface are aligned in a second direction orthogonal to the first direction; and
the liquid crystals of intermediate layers successively stacked between the first layer and the final layer have alignments successively rotated between the first direction and the second direction.

18. The XR display system of claim 11, wherein:
the liquid crystals comprise chiral liquid crystals configured to increase a homogeneity, across the first surface, of a liquid crystal response to the electrical stimulus.

19. The XR display system of claim 11, wherein:
the liquid crystal cell includes a peripheral region giving rise to visual artifacts when light passes through the peripheral region and propagates to the user's eye; and
the XR display system further comprises a dimming filter positioned to block at least a portion of the light passing through the peripheral region.

20. A method of dynamically adapting focal distance to vergence distance in an extended reality (XR) display system, comprising:
displaying virtual visual content at respective positions on image presentation surfaces of image presentation components of a left near-eye optical see-through XR display and right near-eye optical see-through XR display of the XR display system such that a gaze direction of a user's left eye and a gaze direction of the user's right eye intersect at a vergence distance from the user when viewing the virtual visual content on the near-eye optical see-through XR displays; and
switching a dynamic pull lens and a dynamic push lens of each near-eye optical see-through XR display between an active state and an inactive state based on the vergence distance, wherein:
the dynamic push lens is positioned on a world-facing side of the image presentation component of the respective near-eye optical see-through XR display, the dynamic push lens comprising a liquid crystal cell dynamically switchable by an electrical stimulus between an inactive state and an active state, the dynamic push lens being configured to, in the active state, converge environmental light approaching the image presentation component from a world-facing side of the image presentation component, such that the dynamic pull lens in the active state applies a positive optical power to the environmental light; and
the dynamic pull lens is positioned on an eye-facing side of the image presentation component of the respective near-eye optical see-through XR display, the dynamic pull lens comprising a liquid crystal cell dynamically switchable by an electrical stimulus between an inactive state and an active state, the dynamic pull lens being configured to, in the active state, diverge light passing out of an eye-facing side of the image presentation component toward the user's respective eye, such that the dynamic pull lens in the active state applies a negative optical power to the light.

21. A non-transitory computer-readable storage medium, the computer-readable storage medium including instructions that when executed by a processor of a system, cause the system to perform operations comprising:
displaying virtual visual content at respective positions on image presentation surfaces of image presentation components of a left near-eye optical see-through XR display and right near-eye optical see-through XR display of the system such that a gaze direction of a user's left eye and a gaze direction of the user's right eye intersect at a vergence distance from the user when viewing the virtual visual content on the near-eye optical see-through XR displays; and
switching a dynamic pull lens and a dynamic push lens of each near-eye optical see-through XR display between an active state and an inactive state based on the vergence distance, wherein:
the dynamic push lens is positioned on a world-facing side of the image presentation component of the respective near-eye optical see-through XR display, the dynamic push lens comprising a liquid crystal cell dynamically switchable by an electrical stimulus between an inactive state and an active state, the dynamic push lens being configured to, in the active state, converge environmental light approaching the image presentation component from a world-facing side of the image presentation component, such that the dynamic pull lens in the active state applies a positive optical power to the environmental light; and
the dynamic pull lens is positioned on an eye-facing side of the image presentation component of the respective near-eye optical see-through XR display, the dynamic pull lens comprising a liquid crystal cell dynamically switchable by an electrical stimulus between an inactive state and an active state, the dynamic pull lens being configured to, in the active state, diverge light passing out of an eye-facing side of the image presentation component toward the user's respective eye, such that the dynamic pull lens in the active state applies a negative optical power to the light.
